(19) United States
(12) Patent Application Publication
(10) Pub. No.: US 2002/0069108 A1
(43) Pub. Date: Jun. 6, 2002

(54) Apparatus and method for online fundraising

(76) Inventors: Eric Aubertin, San Francisco, CA (US); Eric Vaillancourt, Chateauguay (CA)

Correspondence Address: KENYON & KENYON, ONE BROADWAY, NEW YORK, NY, 10004, US

(21) Appl. No.: 09/929,223

(22) Filed: Aug. 13, 2001

Related U.S. Application Data
(60) Provisional application No. 60/224,716, filed on Aug. 11, 2000.

(51) Int. Cl. G06F 17/60

(52) U.S. Cl. 705/14; 705/26

(57) ABSTRACT

A web site is created that allows fundraising organizations to raise money on a computer network. A fundraising organization sets up a computer network-based fundraising campaign by creating a home page, which is accessible to members of the public over the internet. The home page provides a description of the fundraising organization, as well as the purpose for which money is needed. Participants in the campaign collect e-mail addresses of friends and relatives who may be interested in contributing to the campaign. One or more solicitation messages are sent to these potential supporters, asking the potential supporters to visit the home page and learn more about the fundraising organization and the purpose for the campaign. From the home page, potential supporters are directed to a transactional user interface, where they can buy a product or contribute money in support of the fundraising organization. If the potential supporter chooses to purchase a product, the product is shipped directly to the potential supporter and a certain percentage of the purchase price what is bought goes back to the fundraising organization. If the potential supporter chooses to make a contribution, a certain percentage of what is contributed goes back to the fundraising organization.

### FIELD OF THE INVENTION

The present invention is directed toward the field of raising money on the Internet.

### BACKGROUND OF THE INVENTION

Traditionally, members of a fundraising group would raise money by going door-to-door to sell products, and keeping a certain percentage of the total sales. The percentage kept by the fundraising group is typically quite high—usually somewhere between 25 and 60%. However, this kind of fundraising system is inefficient and, since the individual fundraiser must travel from door-to-door, potentially hazardous. In addition, going door-to-door to sell products requires a substantial investment of time. Not all members of a fundraising group are willing or able to invest the amount of time required to raise a significant amount of money.

Because the number of people who have access to computers is increasing very rapidly, the idea of an online fundraising system appears to be a good way to overcome the problems associated with traditional fundraising methods. Three types of online fundraising systems have been developed: (i) the traditional product model, (ii) the fundraising superstore model, and (iii) the affinity fundraisers model.

The traditional product model involves promoting and selling a fundraising product which schools and groups may buy through the Internet. This model is not very different from the traditional fundraising model. Distributors who have traditionally supplied fundraising products to schools can now simply allow the fundraising organizations to buy these fundraising products through the Internet. However, this does not solve the problems associated with door-to-door selling.

The fundraising superstore model is an extension of the traditional product model. In this model, distributors offer a large selection of fundraising products—virtually anything that might be available at a shopping mall. Distributors charge fundraising organizations wholesale prices for their fundraising products who then make a profit by charging a consumer or supporter a higher price. However, this model also does not solve the problems associated with door-to-door selling.

The affinity fundraisers model is an extension of both the traditional product model and the fundraising superstore model. Members of a community group shop through a central or affinity web site which offers a wide variety of products—again, anything that might be available at a shopping mall. This affinity web site typically contains links to the affiliate programs of known affiliate retailers. Purchasing a product on the web site amounts to purchasing the product directly from the affiliate retailer.

Periodically, a small (perhaps 2%-12%) percentage of the value of customers' purchases are given back to the web site owner in the form of commissions. The web site owner then shares a portion of this commission with the fundraising group. The affiliate process is easy to set up, since in its simplest case it just requires a web site owner to create links to affiliate retailers on his/her web site. However, there is no way for a fundraising group to advertise that they are associated with this affinity web site. Nor is there a way to target people who are particularly likely to contribute, such as friends and relatives of those involved in the fundraising group. In addition, the percentage return on sales is significantly lower than that associated with traditional fundraising.

Accordingly, what is needed is a way for a fundraising group to efficiently raise money on the Internet.

### SUMMARY OF THE INVENTION

In accordance with an embodiment of the present invention, a web site is created that allows Fundraising Organizations to raise money online.

In an embodiment of the invention, a Fundraising Organization sets up an online fundraising Campaign by creating a fundraising Home Page, which is accessible to members of the public over the Internet. The Home Page provides a description of the Fundraising Organization, and the purpose for which money is needed. Participants in the Campaign collect e-mail addresses of friends and relatives who may be interested in contributing to the Campaign. One or more e-mail messages (the Solicitation Messages) are sent to these Potential Supporters, asking the Potential Supporters to visit the Home Page and learn more about the Fundraising Organization and the purpose for the Campaign. From the Home Page, Potential Supporters are directed to a transactional Web page, where they can buy a product or contribute money in support of the Fundraising Organization. If the Potential Supporter chooses to purchase a product, the product is shipped directly to the Potential Supporter and a certain percentage of the purchase price of what is bought goes back to the Fundraising Organization. If the Potential Supporter chooses to make a contribution, a certain percentage of what is contributed goes back to the Fundraising Organization.

Another aspect of the present invention involves including a link to the Home Page in the Solicitation Message.

Another aspect of the present invention involves personalizing the Home Page for the Potential Supporter who follows the link contained in the Solicitation Message.

A further aspect of the present invention involves associating a purchase or contribution made by a Supporter with a Participant (this is called a Sale made by the Participant), and providing prizes for Participants based on their total Sales.

Yet another aspect of the present invention involves arranging the Participants into Sub-Groups.

Another aspect of the present invention involves allowing Campaign Managers and Participants to monitor the total Sales made by Participants and Sub-Groups.

Yet another aspect of the present invention involves encouraging Supporters to find additional Potential Supporters.

The advantages of the invention will appear more clearly from examination of the following detailed description and accompanying figures, in which the preferred embodiments of the invention have been set forth.

### BRIEF DESCRIPTION OF THE DRAWINGS

FIG. 1 shows how a Campaign Manager would practice an embodiment of the present invention.

FIG. 2 shows an online registration form of an embodiment of the invention which is used to collect information about a Fundraising Organization.

FIG. 3 shows a login screen of an embodiment of the invention for a Campaign Manager.

FIGS. 4 and 7 show a form of an embodiment of the invention which is used to collect information about a Campaign.

FIG. 5 shows a screen of an embodiment of the invention that displays all the Campaigns set up by one Campaign Manager.

FIGS. 6 and 8 show a Web page of an embodiment of the invention which is used to create a new Campaign.

FIG. 9 shows an embodiment of the invention Home Page.

FIG. 10 shows a Web page of an embodiment of the invention which is used to create a new e-mail account.

FIG. 11 shows an e-mail account manager screen of an embodiment of the invention.

FIG. 12 shows the Sub-Group manager screen of an embodiment of the invention.

FIG. 13 shows a screen of an embodiment of the invention that allows the Campaign Manager to modify information about a Participant.

FIG. 14 shows a screen of an embodiment of the invention that allows a Campaign Manager to search the Database for Participants' e-mail accounts.

FIG. 15 shows a screen of an embodiment of the invention that displays the results of the search conducted in FIG. 14.

FIG. 16 shows a screen of an embodiment of the invention used to compose an e-mail message to a Participant.

FIG. 17 shows a screen of an embodiment of the invention which allows the Campaign Manager to modify information about a Participant's e-mail account.

FIG. 18 shows a screen of an embodiment of the invention that displays a list of any nonfunctional e-mail addresses associated with a Campaign.

FIG. 19 shows a screen of an embodiment of the invention which the Campaign Manager may access to get information about how the Campaign is progressing.

FIG. 20 shows a screen of an embodiment of the invention that the Campaign Manager uses to see statistics about the products that have been sold during a Campaign.

FIG. 21 shows the screen of an embodiment of the invention that the Campaign Manager may view to see statistics about the Participants involved in the Campaign.

FIG. 22 shows the screen of an embodiment of the invention that the Campaign Manager may view to see statistics about the Sub-Groups involved in the Campaign.

FIG. 23 shows how a Participant would practice an embodiment of the present invention.

FIG. 24 shows a sample inbox of an embodiment of the invention.

FIG. 25 shows a sample e-mail message of an embodiment of the invention that can be read by a Participant using her electronic mailbox.

FIG. 26 shows an embodiment of the invention screen that a Participant uses to respond to an e-mail message.

FIG. 27 shows the screen of an embodiment of the invention that a Participant uses to forward an e-mail message.

FIG. 28 shows the screen of an embodiment of the invention that a Participant uses to compose a new e-mail message.

FIG. 29 shows how a signature file of an embodiment of the invention can be created by a Participant.

FIG. 30 shows a sample signature file of an embodiment of the invention as it appears in an e-mail message.

FIGS. 31 and 45 shows the screen of an embodiment of the invention that appears when someone creates an e-card.

FIG. 32 shows a preview screen of an embodiment of the invention for the e-card.

FIG. 33 shows sample formats of an embodiment of the invention of business cards.

FIG. 34 shows business cards of an embodiment of the invention suitable for printing.

FIG. 35 shows a part of the electronic mailbox of an embodiment of the invention that allows a Participant to view the Participant's total Sales.

FIG. 36 shows how a Supporter would practice the embodiment of the present invention.

FIG. 37 shows a sample Solicitation Message of an embodiment of the invention that is sent from a Participant to a Potential Supporter.

FIG. 38 shows a sample Home Page of an embodiment of the invention.

FIG. 39 shows a screen of an embodiment of the invention which provides a Potential Supporter the ability to search for a Fundraising Organization to support.

FIG. 40 shows the Home Page of an embodiment of the invention as seen by a Potential Supporter who does not follow a link contained in the Solicitation Message.

FIG. 41 shows a Web page of an embodiment of the invention displaying products.

FIG. 42 displays a shopping basket of an embodiment of the invention.

FIG. 43 shows the page of an embodiment of the invention which allows Potential Supporters to make a direct financial contribution in support of a Campaign.

FIG. 44 shows a screen of an embodiment of the invention which can be used to thank Supporters.

FIG. 46 shows a preview of a tell-a-friend message of an embodiment of the invention.

FIG. 47 shows a screen of an embodiment of the invention that may appear to the Administrator after the Administrator logs in.

FIG. 48 shows the screen of an embodiment of the invention that an Administrator would use to search for a Campaign Manager.

FIG. 49 shows the screen of an embodiment of the invention that displays the results of the Administrator's search.

FIG. 50 shows a screen of an embodiment of the invention which allows the Administrator to deactivate a Campaign.

FIG. 51 shows a screen of an embodiment of the invention which allows an Administrator to change the products that are displayed along with a particular Campaign.

FIG. 52 shows a screen of an embodiment of the invention which allows an Administrator to add a product.

FIG. 53 provides a schematic representation of an embodiment of the invention of a possible method for interconnecting components of a networked computer system.

FIG. 54 (comprising sub-figures 54a through 54h) shows an embodiment of how the components of the online fundraising system may be inter-related.

### DETAILED DESCRIPTION OF THE PREFERRED EMBODIMENT

A brief definition of the terms used to describe an embodiment of the invention is provided below. It will be evident to one skilled in the art that other variations of these definitions correspond to other embodiments that are within the spirit and scope of the invention.

Administrator: The organization that manages the fundraising Web site.

Administrator Home Page: The home page of the fundraising Web site.

Campaign: A series of steps taken by a Fundraising Organization, in conjunction with an Administrator, for the purpose of raising money for the Fundraising Organization.

Campaign Manager: A person who is in charge of setting up a Campaign for a Fundraising Organization.

Database: A relational database by way of example only, or other existing or future and appropriate database used to store all information about a Campaign—for example, the Participants, Potential Supporters, etc.

Fundraising Organization: The organization that is trying to raise money.

Group: All the Participants associated with a particular Campaign.

Campaign Home Page: A Web page associated with a particular Campaign. It provides Campaign information about the Fundraising Organization that is running the Campaign. The Home Page is stored on the Web site created by the Administrator.

Participant: A member of the Fundraising Organization who is participating in the Campaign. For example, if the fundraising organization is a school, and the students are asked to help raise money, then these students would be called Participants.

Potential Supporter: A person or organization who may purchase a product in support of or contribute money to a Campaign. A Supporter is also considered to be a Potential Supporter.

Sale (made by Participant): A purchase made by a Supporter, or money contributed by a Supporter, that is associated with a particular Participant, is said to be a Sale made by a Participant.

Sale (made by Sub-Group): A purchase made by a Supporter, or money contributed by a Supporter, that is associated with any Participant in a particular Sub-Group, is said to be a Sale made by a Sub-Group.

Solicitation Message: Any of a number of e-mail messages that are sent from a Participant, or by the Campaign Manager on behalf of the Participant, to a Potential Supporter, asking the Potential Supporter to support the Fundraising Organization. The Solicitation Message may or may not have a hyperlink back to the Fundraising Organization's Home Page. In addition the Solicitation Message may be personalized with a personal hyperlink, wherein the personal hyperlink includes the information necessary to identify the Potential Supporter to the system. In this manner, a Supporter following their personal hyperlink would arrive at a web page personalized for them (which may include for example greeting the Supporter by name). As an added feature the system would be able to automatically track that Supporters interaction with the web site, without requiring them to log in.

Sub-Group: A group of Participants associated with a particular Campaign, that may not include all the Participants associated with a particular Campaign.

Supporter: A person or organization who has purchased a product or contributed money in support of a Campaign.

Web: The World-Wide-Web.

Different aspects of embodiments of the present invention are experienced by different individuals involved with it. For example, the Campaign Manager experiences certain aspects of the invention that are different than those experienced by the Participant. Accordingly, embodiments of the invention will be described as it is experienced by (i) a Campaign Manager, (ii) a Participant, (iii) a Potential Supporter, and (iv) an Administrator.

The Invention as Experienced by the Campaign Manager

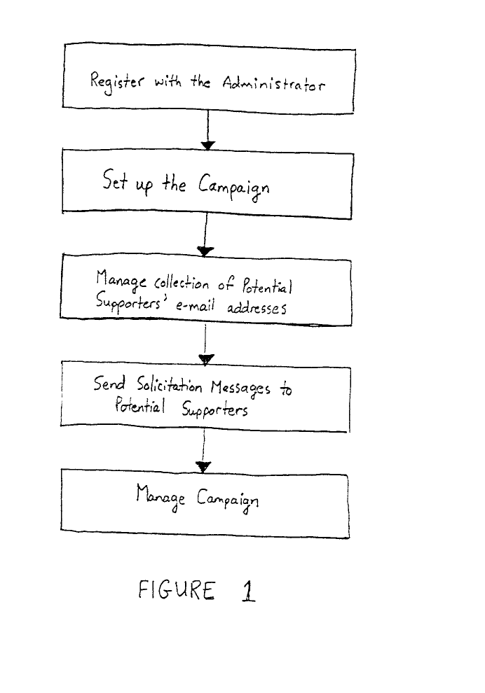

FIG. 1 shows how a Campaign Manager would practice an embodiment of the present invention. The Campaign Manager's involvement comprises the following steps:

1. Registering with the Administrator;

2. Setting up the Campaign;

3. Managing the collection of Potential Supporters' e-mail addresses;

4. Sending Solicitation Messages to Potential Supporters; and

5. Managing the Campaign.

Registering with the Administrator

The Administrator must first collect information about the Fundraising Organization before a Campaign can be created. FIG. 2 shows an online registration form which can be used to collect information about a Fundraising Organization. The form should be filled out by the Campaign Manager. Examples of information that may be collected include the first and last name of the Campaign Manager (boxes 5 and 10), the title (e.g., Principal, Pastor, etc.) of the Campaign Manager (box 15), the name of the Fundraising Organization (box 20), the type of group (e.g., school, church, etc.; box 25), the Fundraising Organization's tax identification number (box 30), the number of Participants (box 35), the official address of the Fundraising Organization (boxes 40, 10 45, 50, and 55), the Campaign Manager's email address (box 60), information about when the Campaign Manager may be reached over the telephone (box 65), the Campaign Manager's fax number (box 75), and the number of campaigns that the Campaign Manager anticipates running each year (box 80). The Campaign Manager may also be asked to select an identification number (box 85). If the Campaign Manager selects the submit button 90, then the information listed on the page will be submitted to the Administrator. If the Campaign Manager selects the cancel button 95, then the information listed on the page will not be submitted or saved. If the information is submitted to the Administrator, then the Administrator will assign a username and password to the Campaign Manager so that the Campaign Manager can begin setting up a Campaign. Those skilled in the art will recognize that the online registration form provided in FIG. 2 is only one example of many different registration forms which may be used in accordance with the present invention, and that many different kinds of information beyond that listed in FIG. 2 may be collected using similar registration forms.

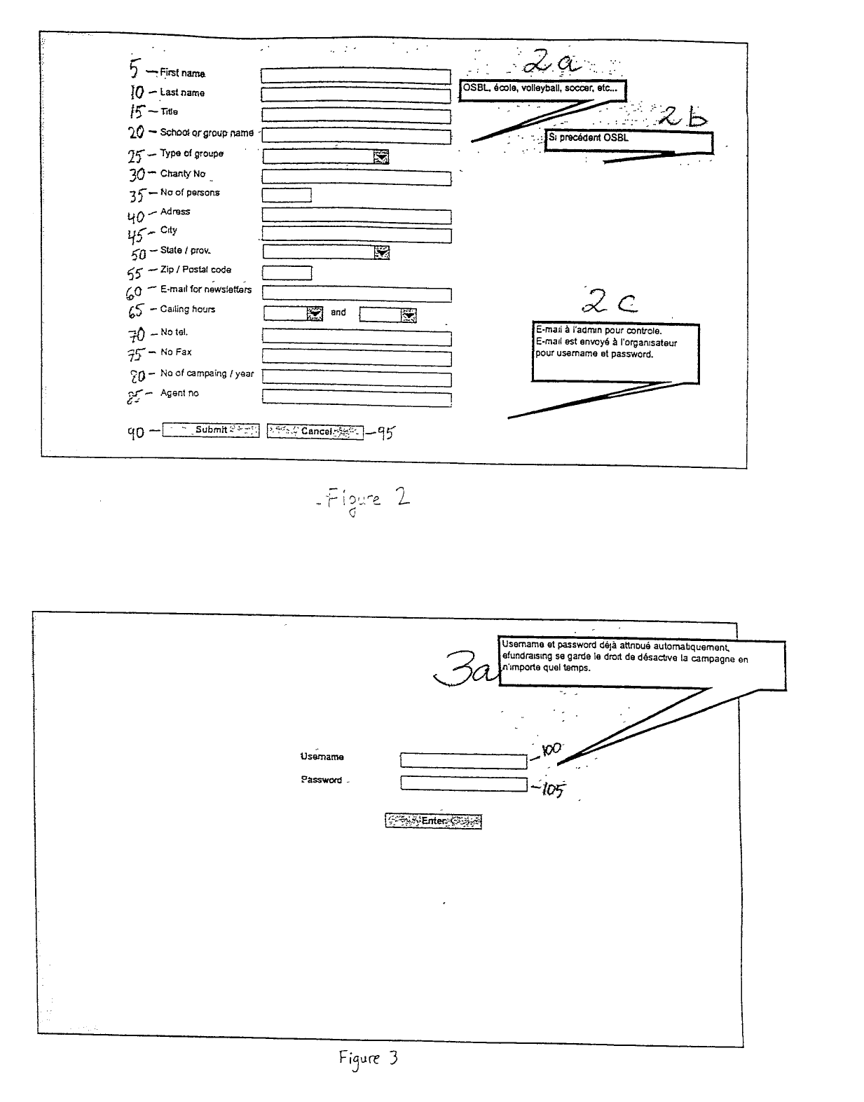

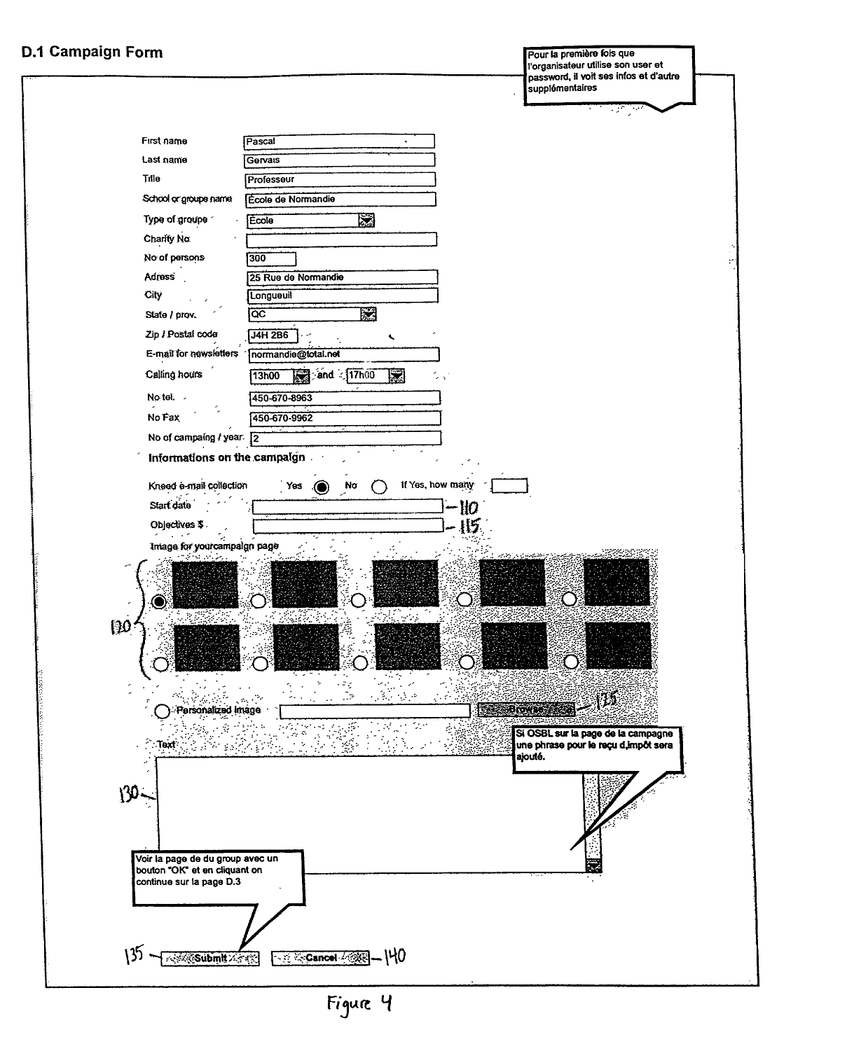

The Web pages accessible to the Campaign Manager are typically password-protected. FIG. 3 shows a login screen for a Campaign Manager. The Campaign Manager would be asked to enter a username (box 100) and password (box 105) in order to be able to see information associated with the Campaign. Both the username and the password can be assigned by the Administrator. The Campaign Manager may be allowed to change their username and/or password, although the Administrator should always maintain access to the Campaign Manager's account (for example, by providing an Administrator username and password that allows access to all accounts).

Setting up the Campaign

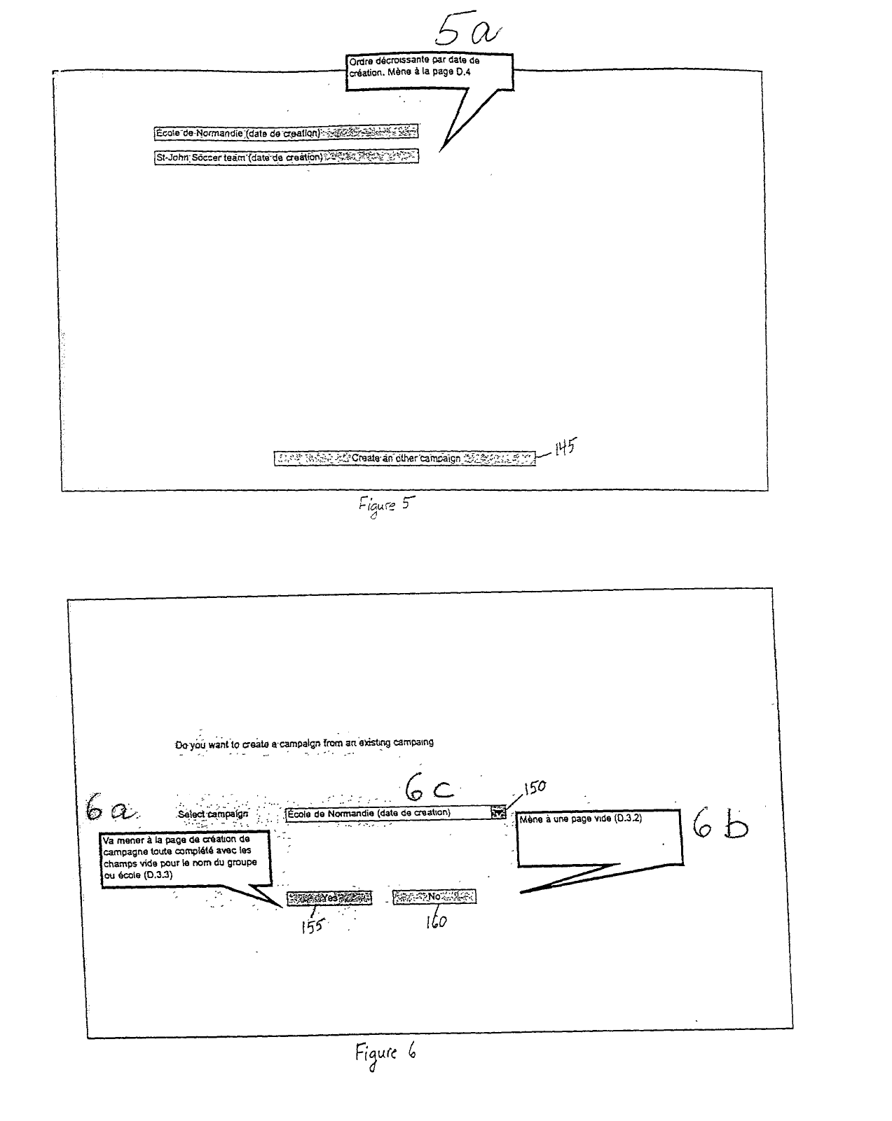

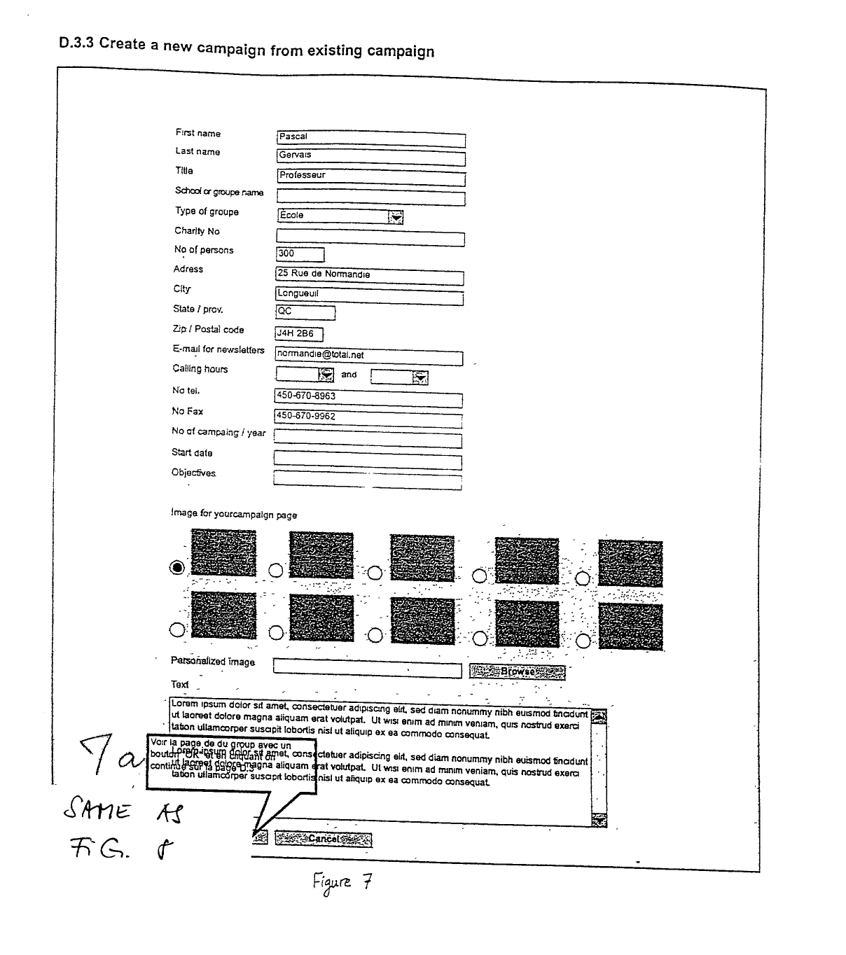

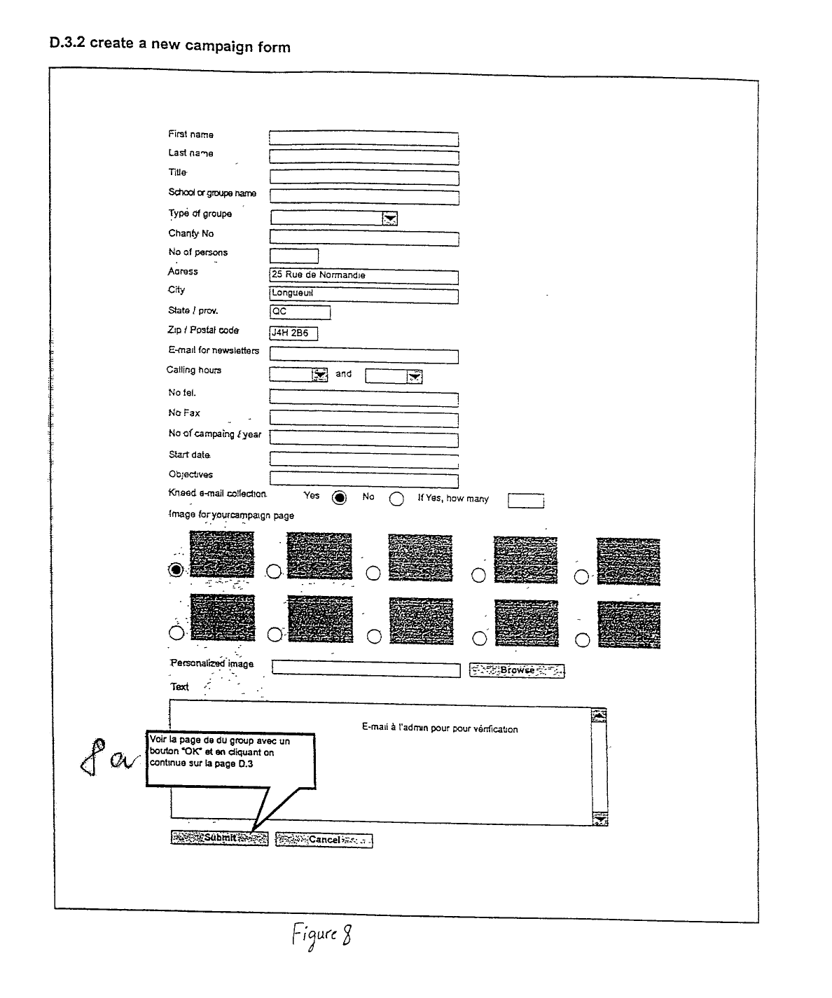

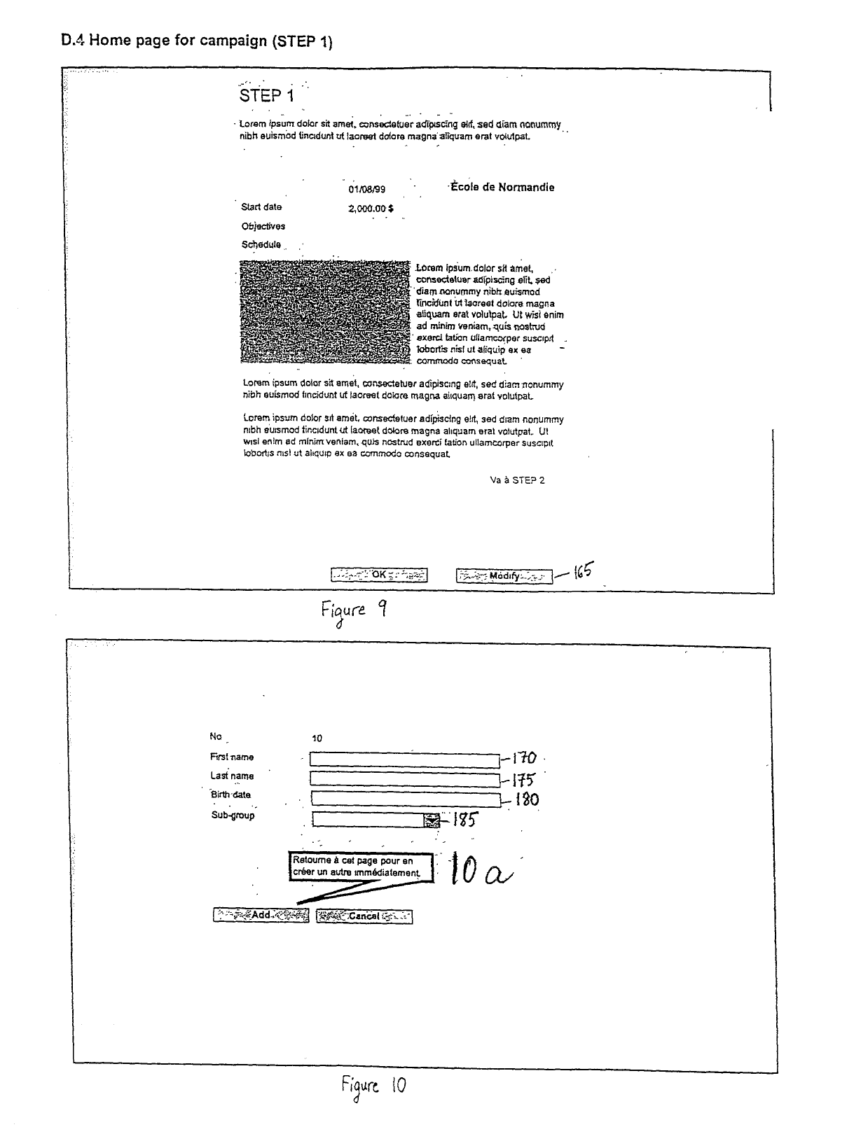

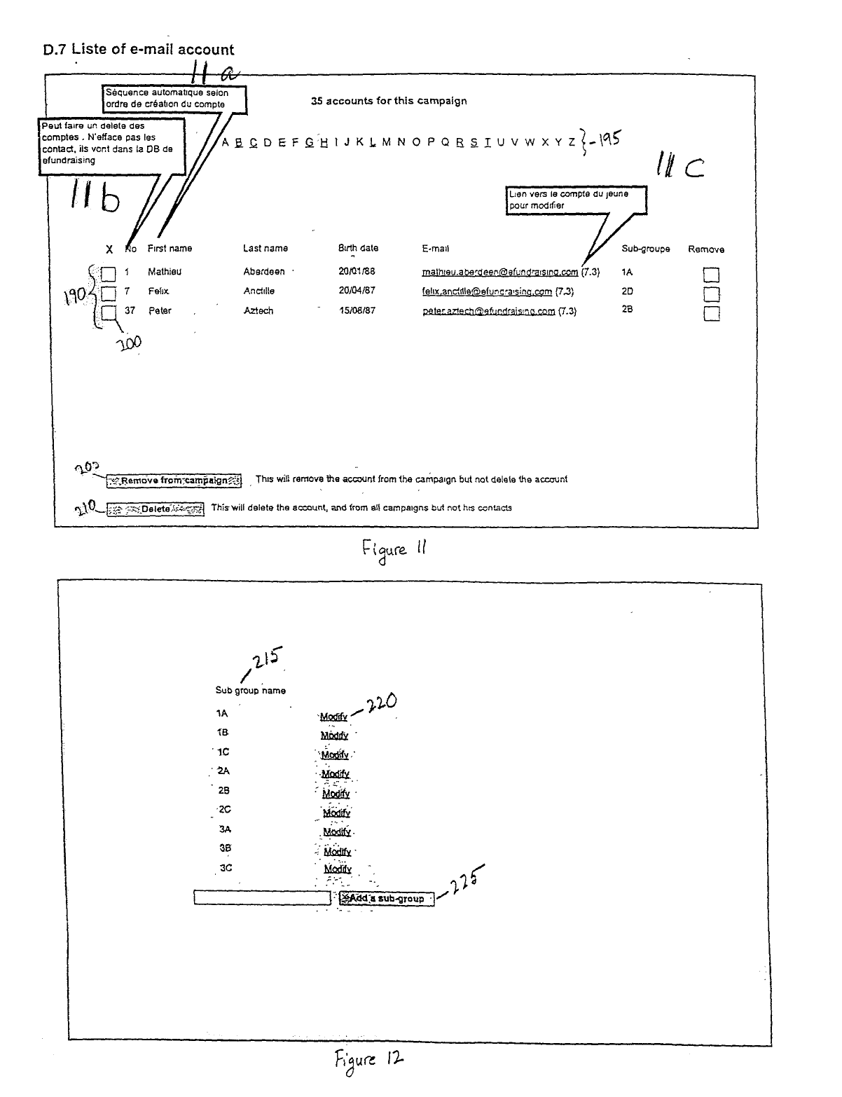

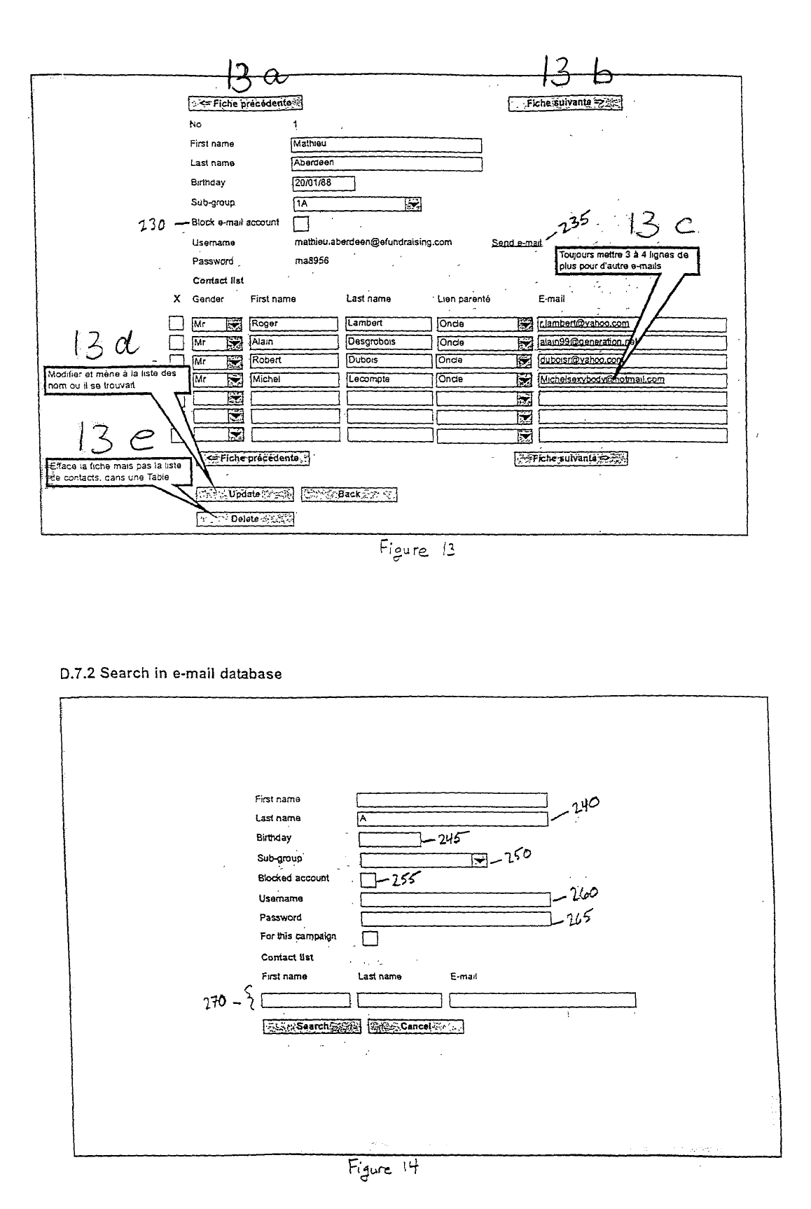

FIG. 4 shows a campaign registration form, which can be used to collect information about a Campaign. All of the information which was entered in the online registration form described in FIG. 2 is provided in the appropriate boxes on the campaign registration form. In addition, the Campaign Manager will be asked to provide additional information on the Campaign. For example, the Campaign Manager can specify the starting date of the Campaign (box 110), and the amount of money that needs to be raised (box 115). This information will be displayed on the Fundraising Organization's Home Page. Also, the Campaign Manager may choose an image to be displayed on the Home Page by clicking on one of the image buttons 120. Alternatively, the Campaign Manager may provide their own image to be displayed on the Home Page by pressing button 125 and entering the location of an image file on a local computer. The Campaign Manager may enter text to be displayed on the Home Page by typing the text in box 130. If the Fundraising Organization entered a tax exemption number in box 30, then a message stating that contributions to the fundraising organization are tax deductible will be automatically appended to the text typed by the Campaign Manager once the Campaign Manager presses the submit button 135. If the cancel button 140 is pressed, then none of the information on the page will be submitted to the Administrator.

Once the information is submitted to the Administrator, the Home Page may be automatically generated for the Campaign. Alternatively, the Administrator may simply provide the Campaign Manager with Web space, but require the Campaign Manager (or someone under their direction) to create the Home Page themselves. Those skilled in the art will recognize that the campaign registration form provided in FIG. 4 is only one example of many different registration forms which may be used in accordance with the present invention, and that many different kinds of information beyond that listed in FIG. 4 may be collected using similar registration forms.

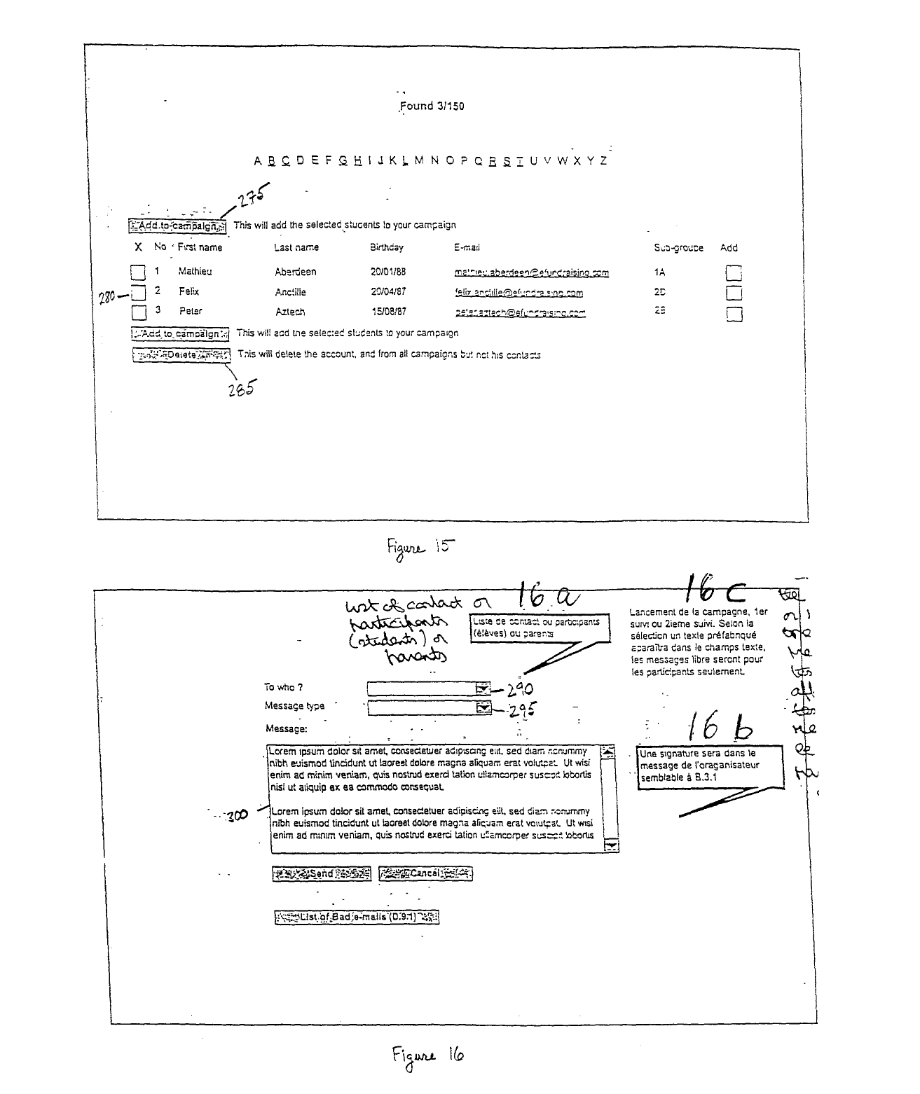

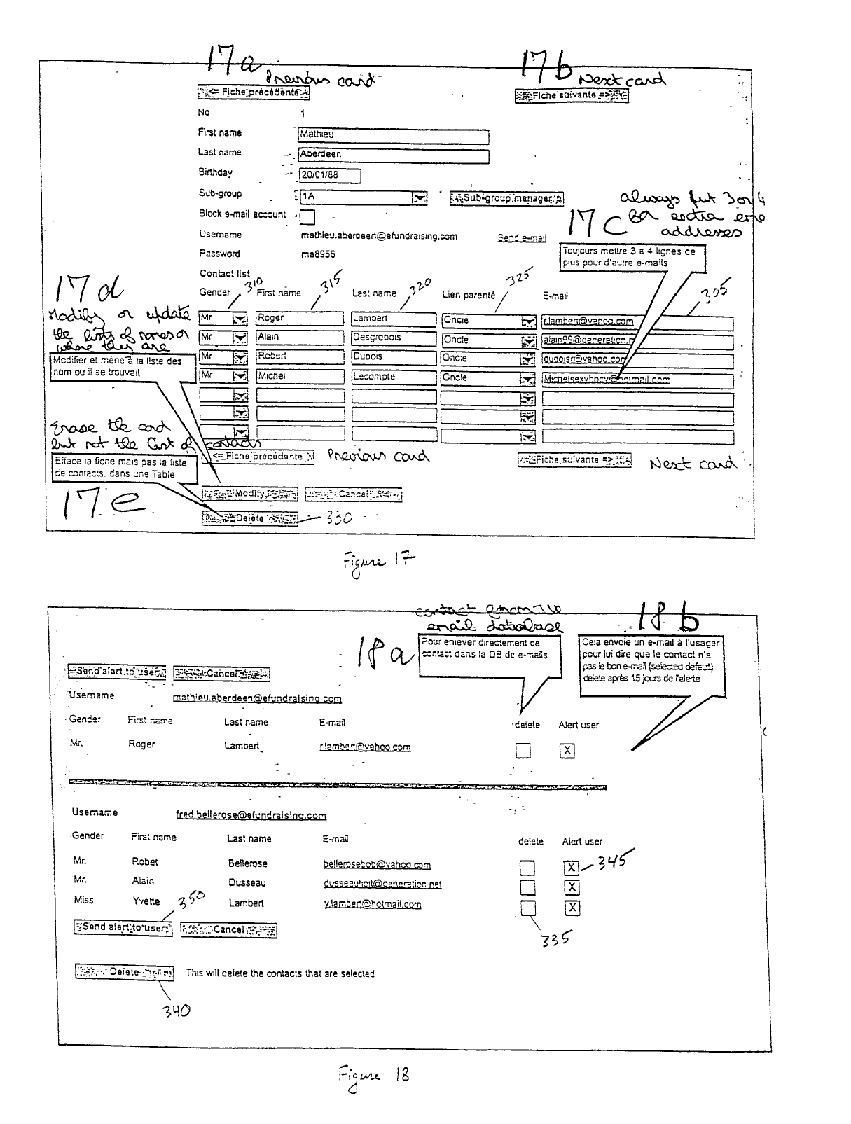

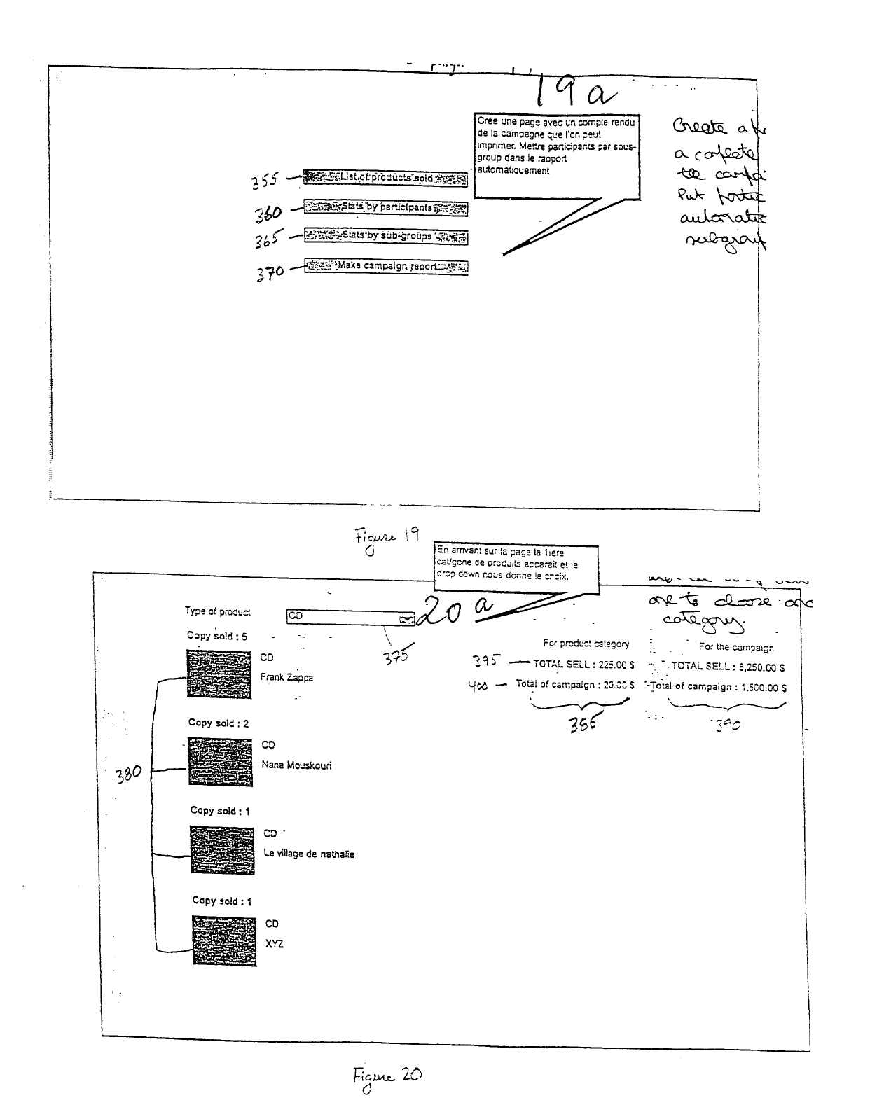

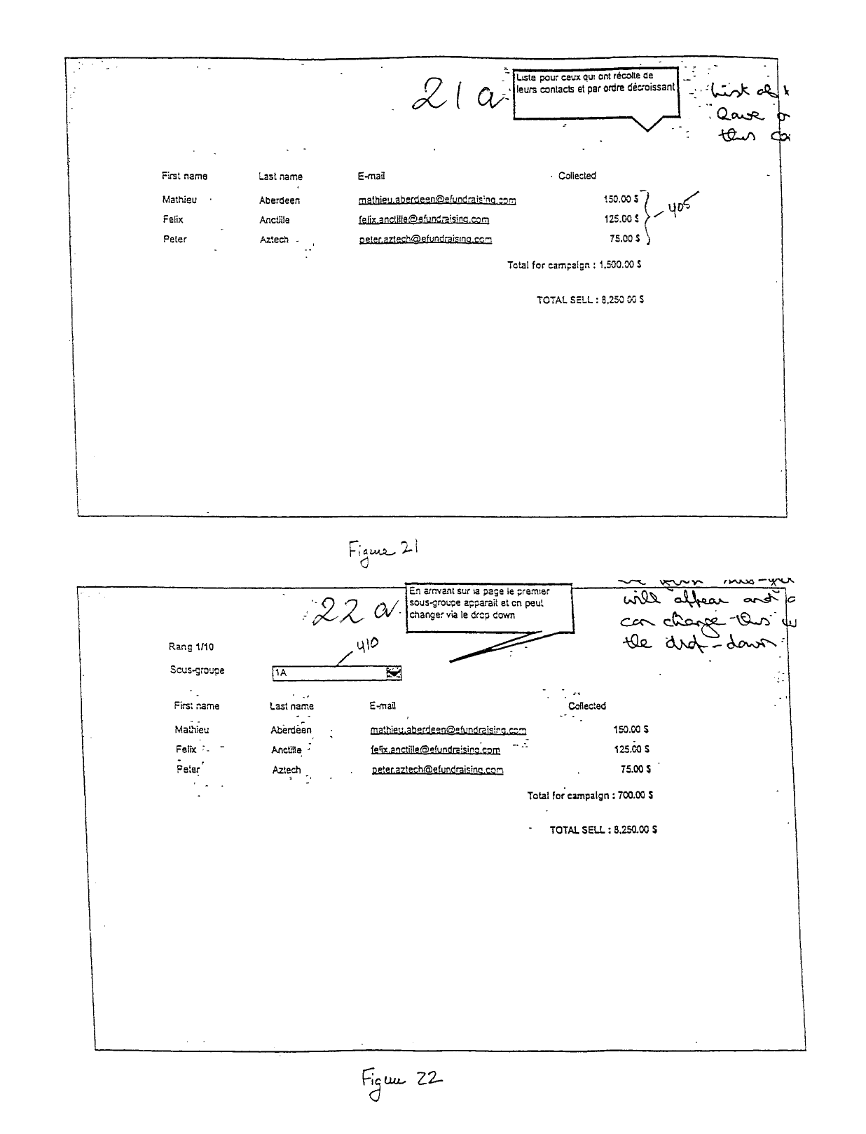

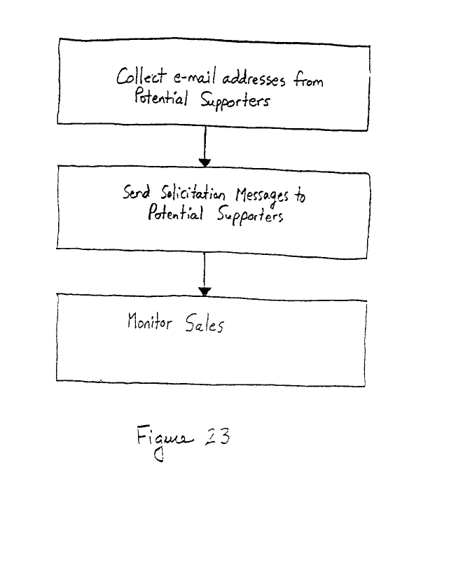

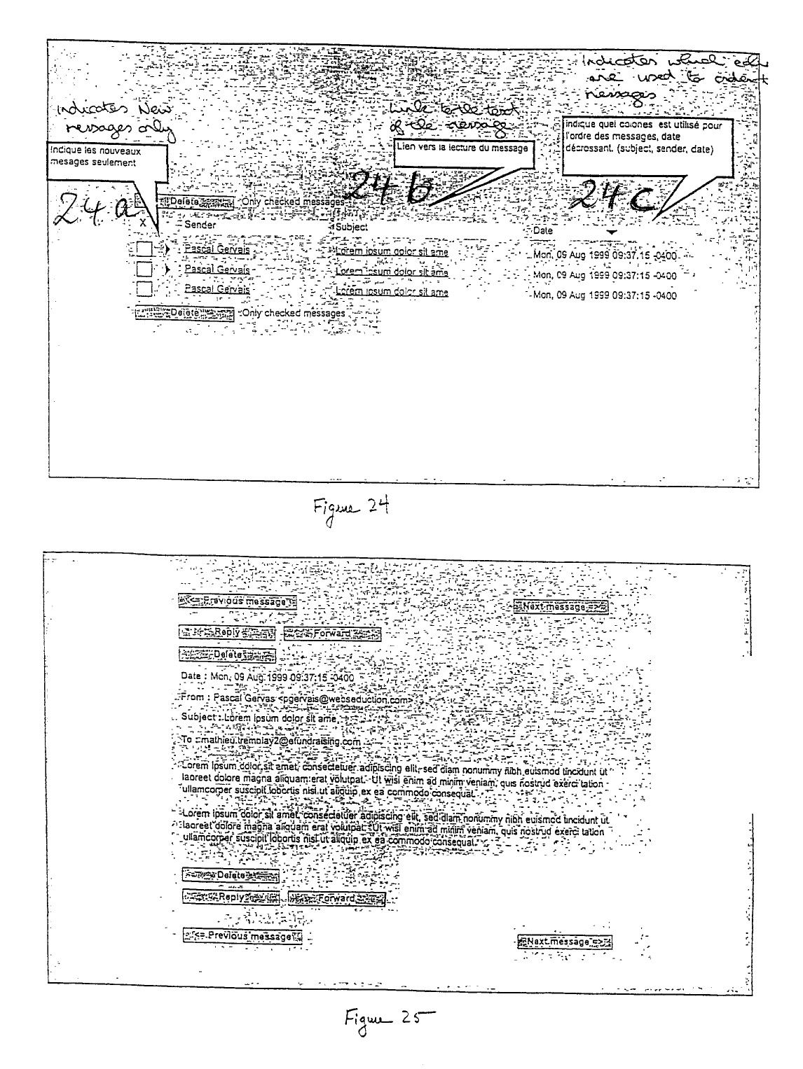

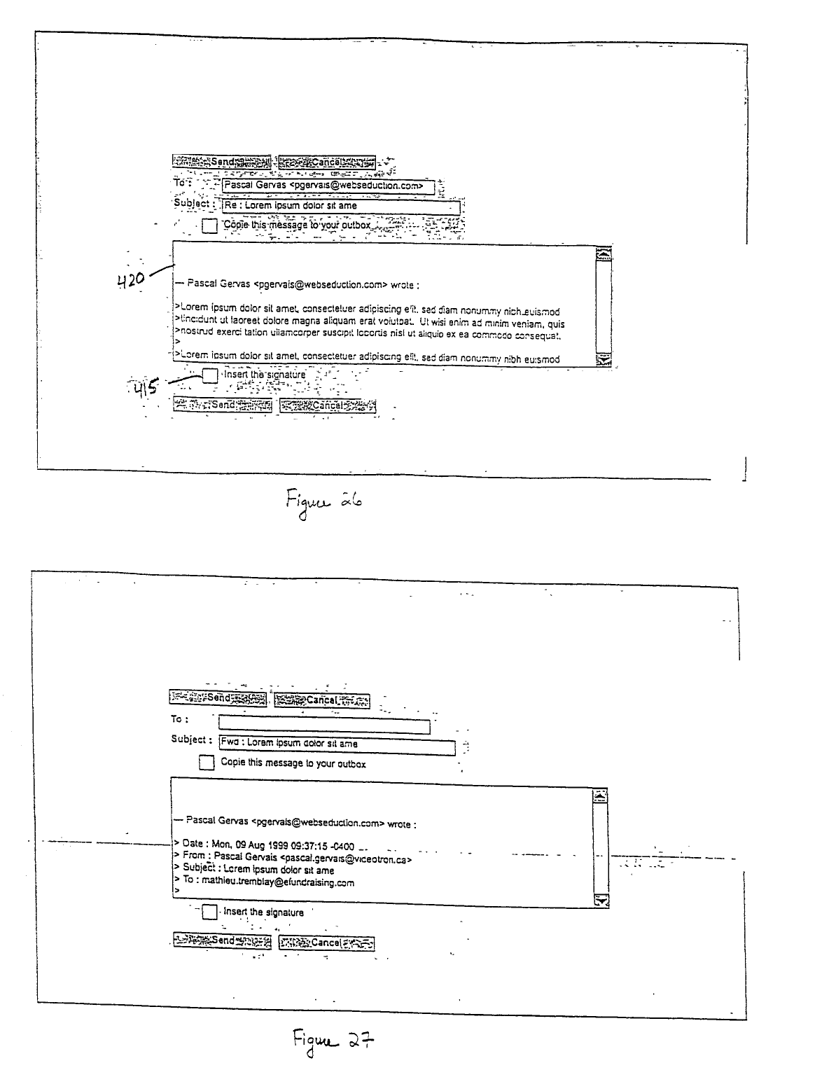

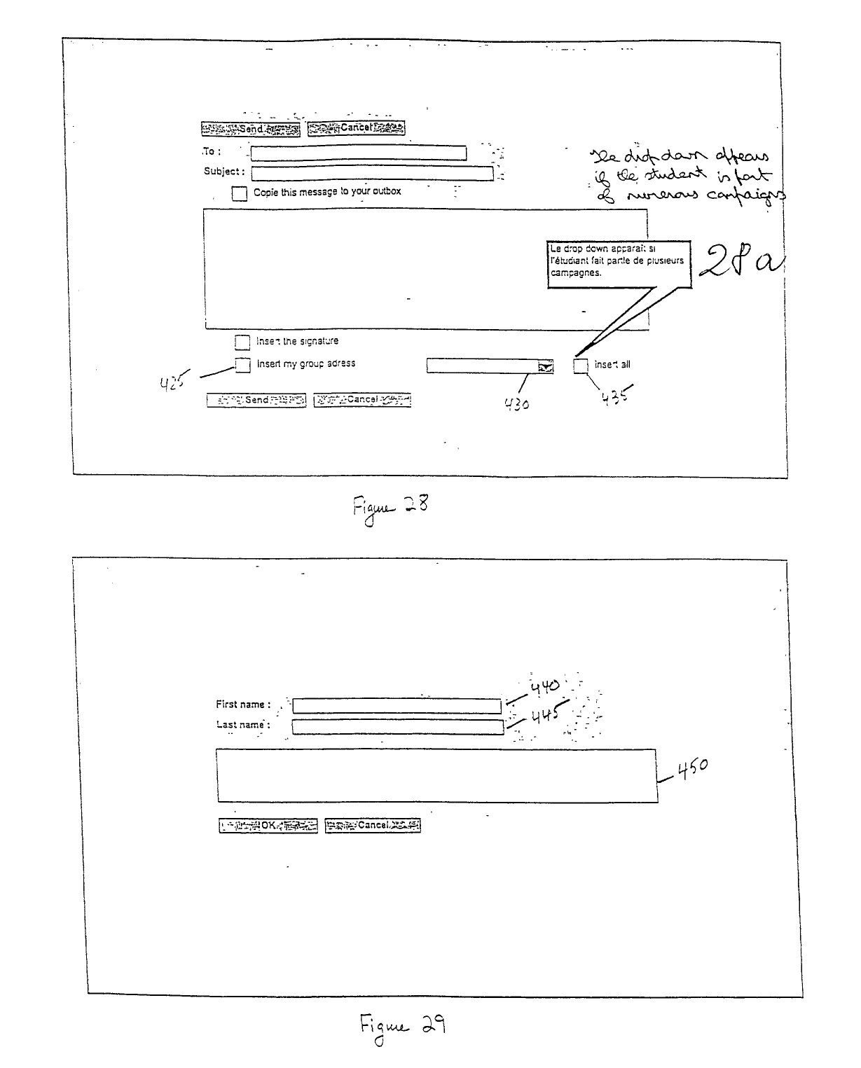

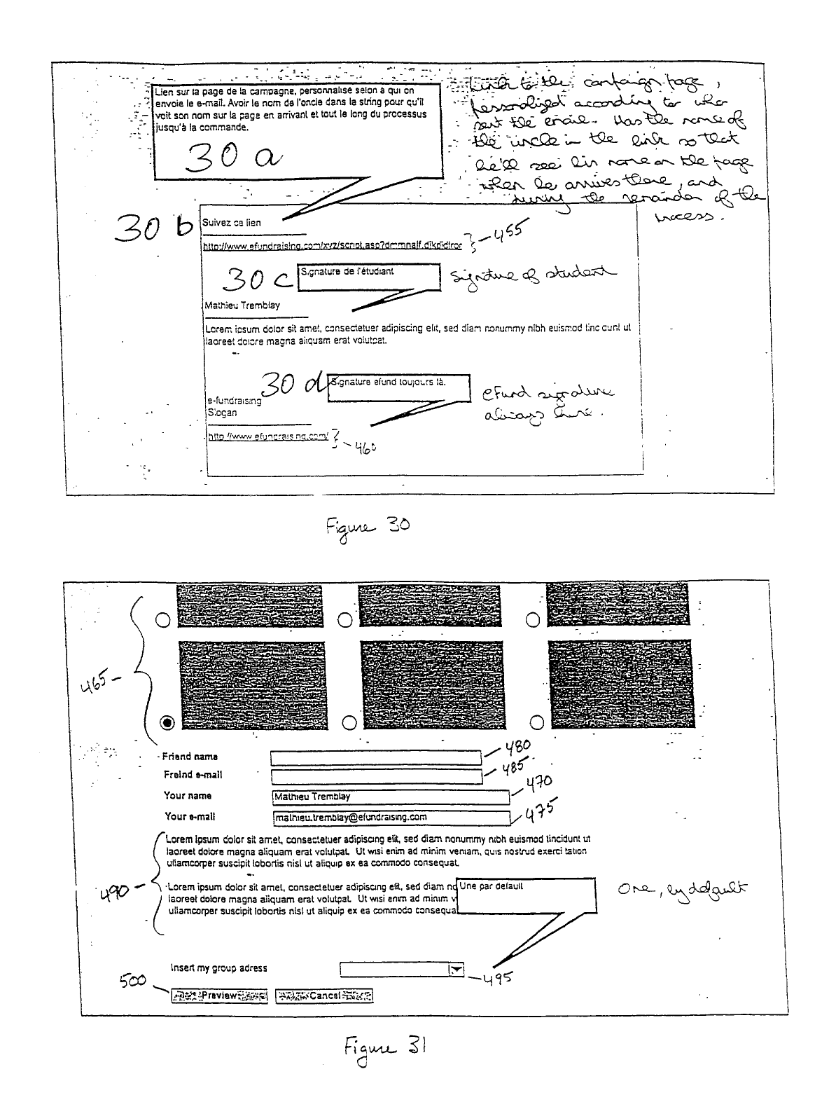

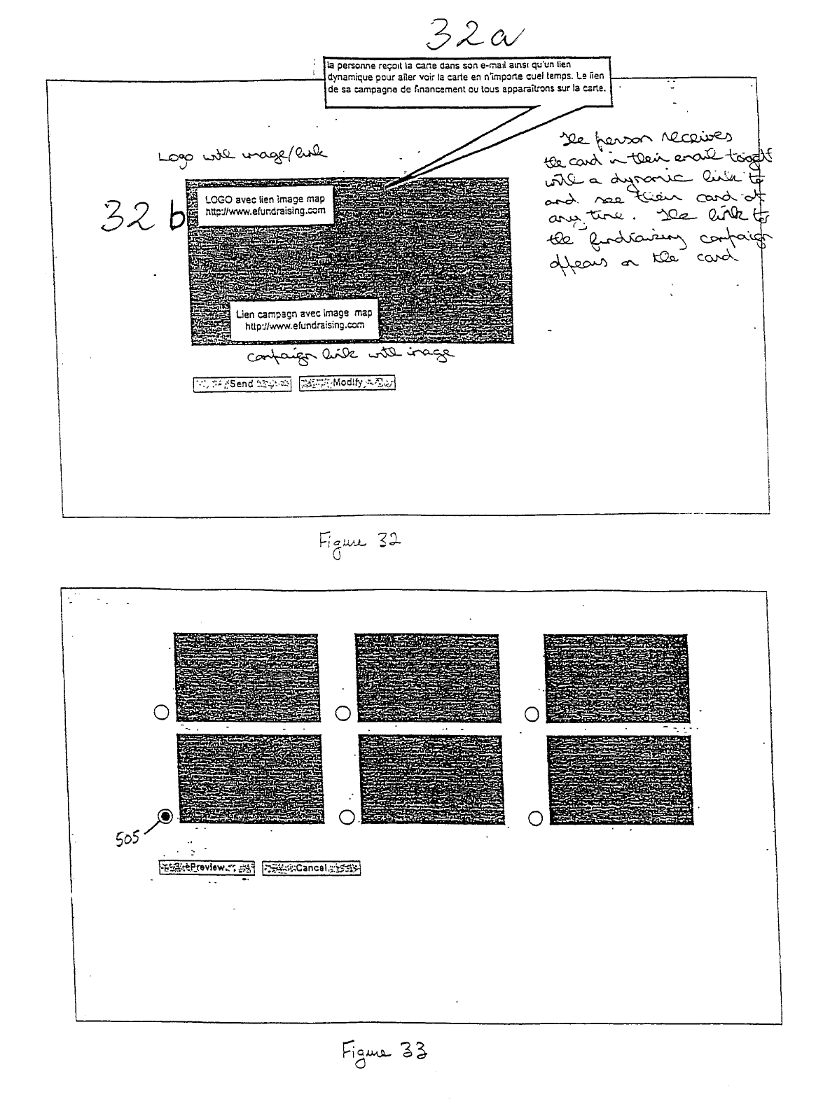

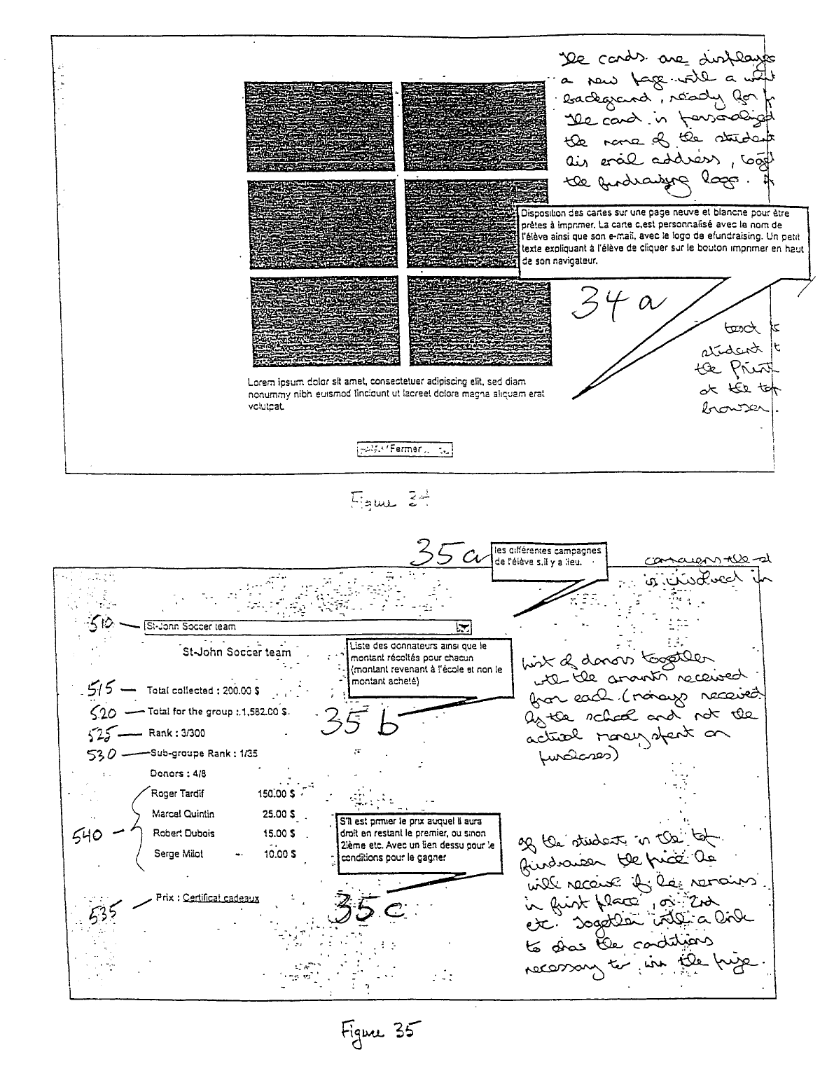

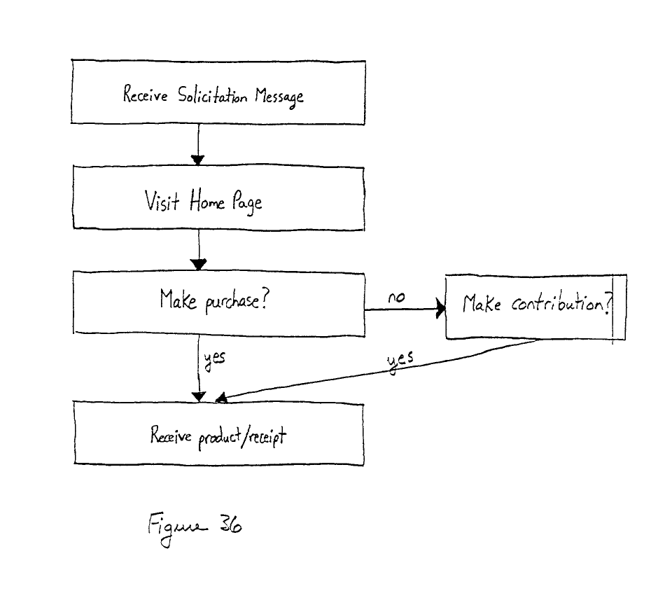

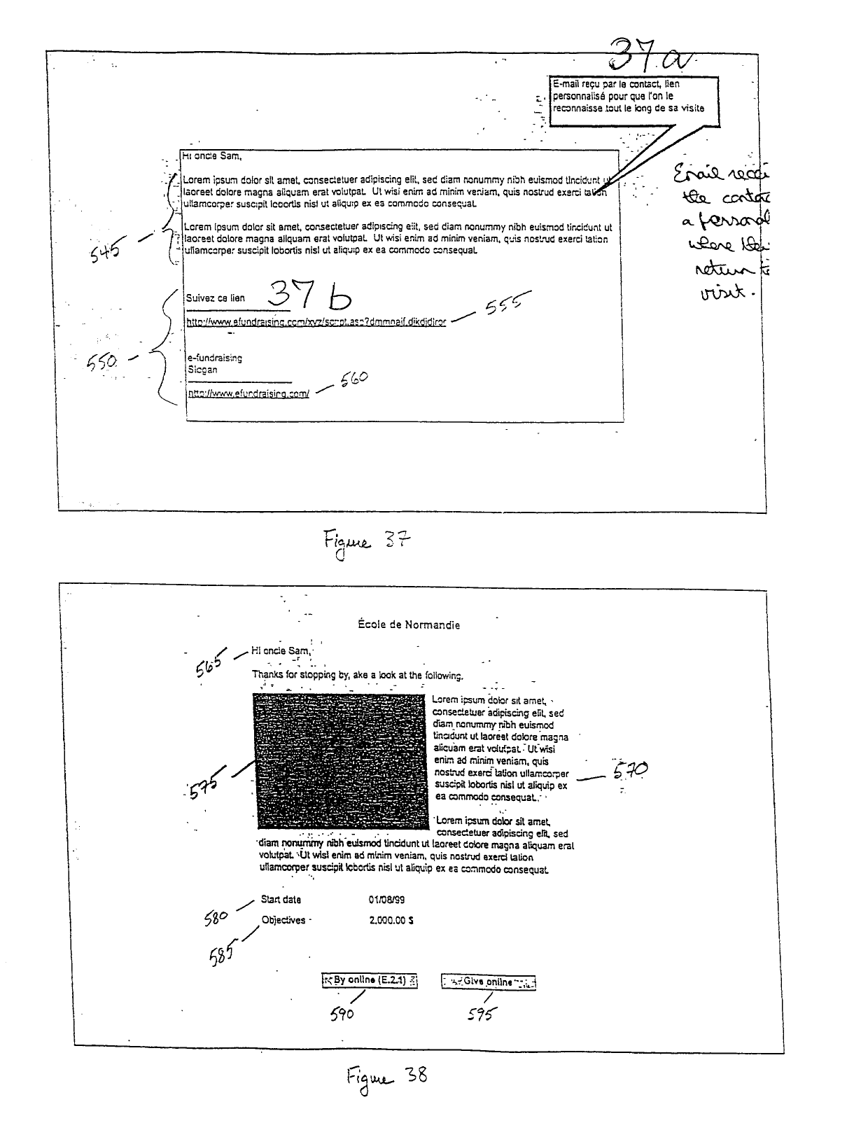

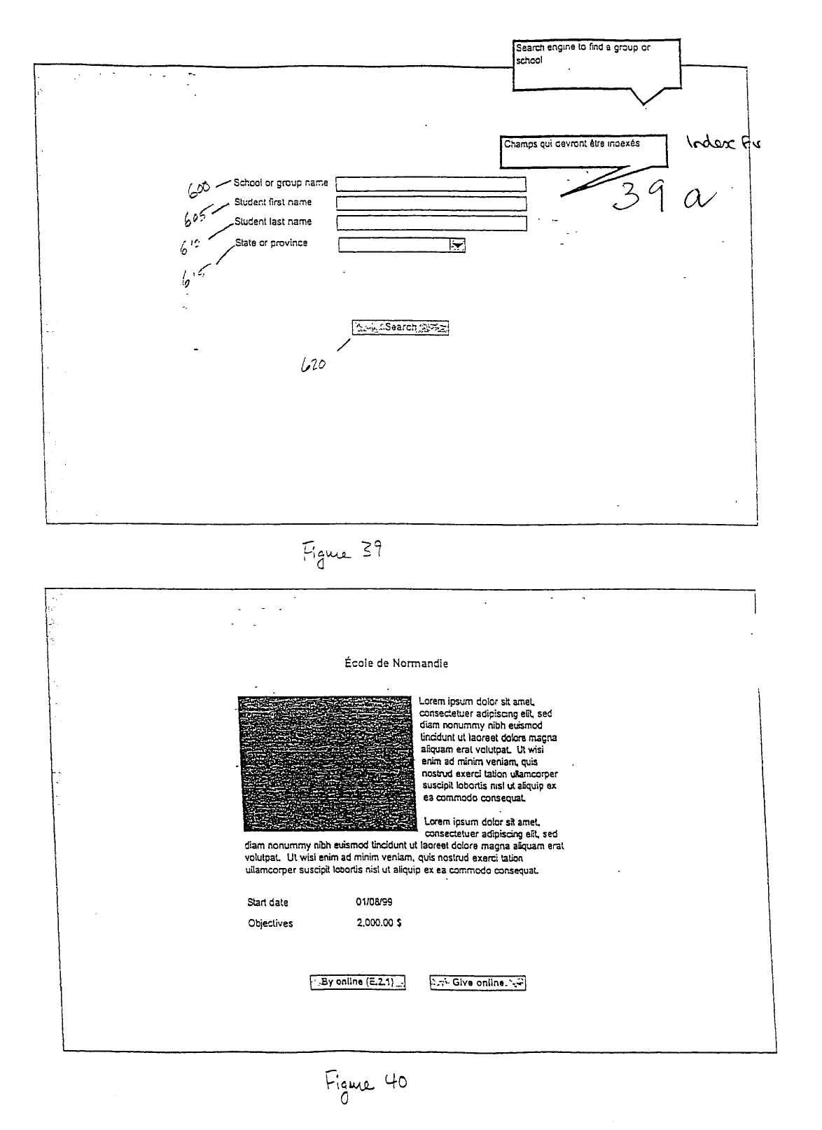

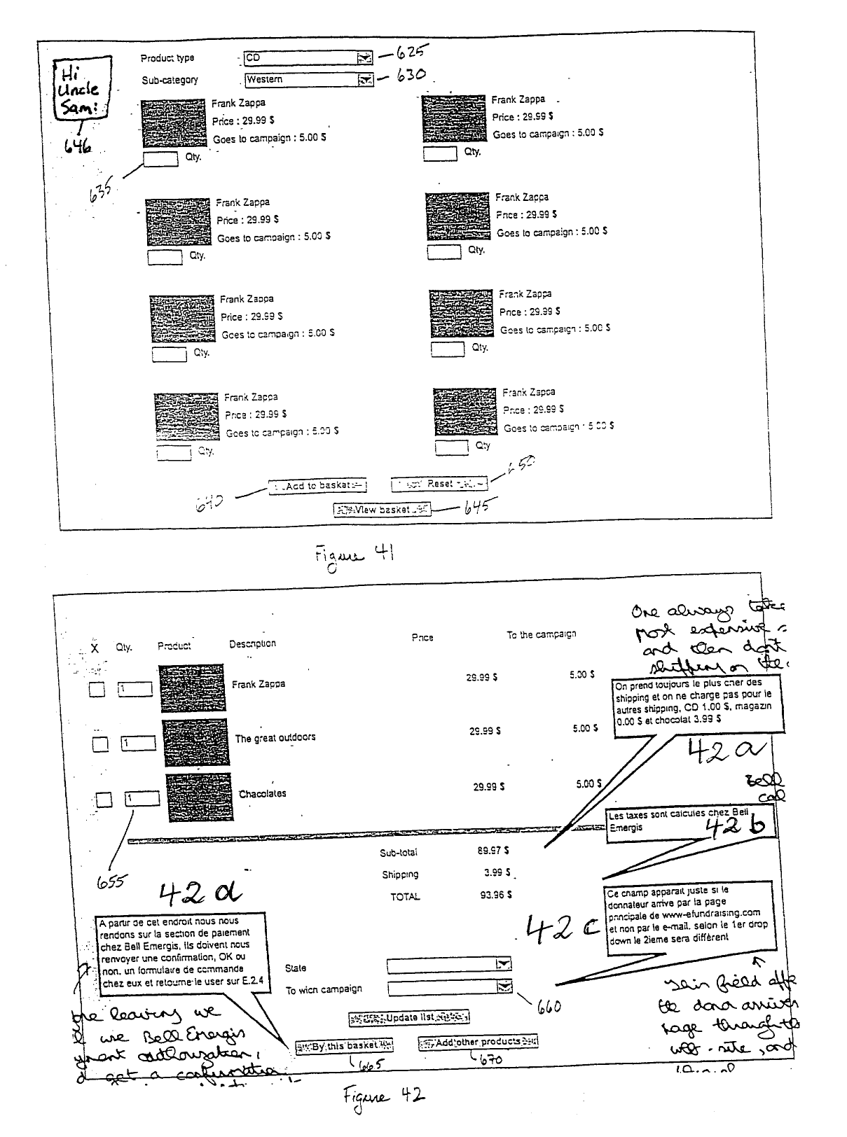

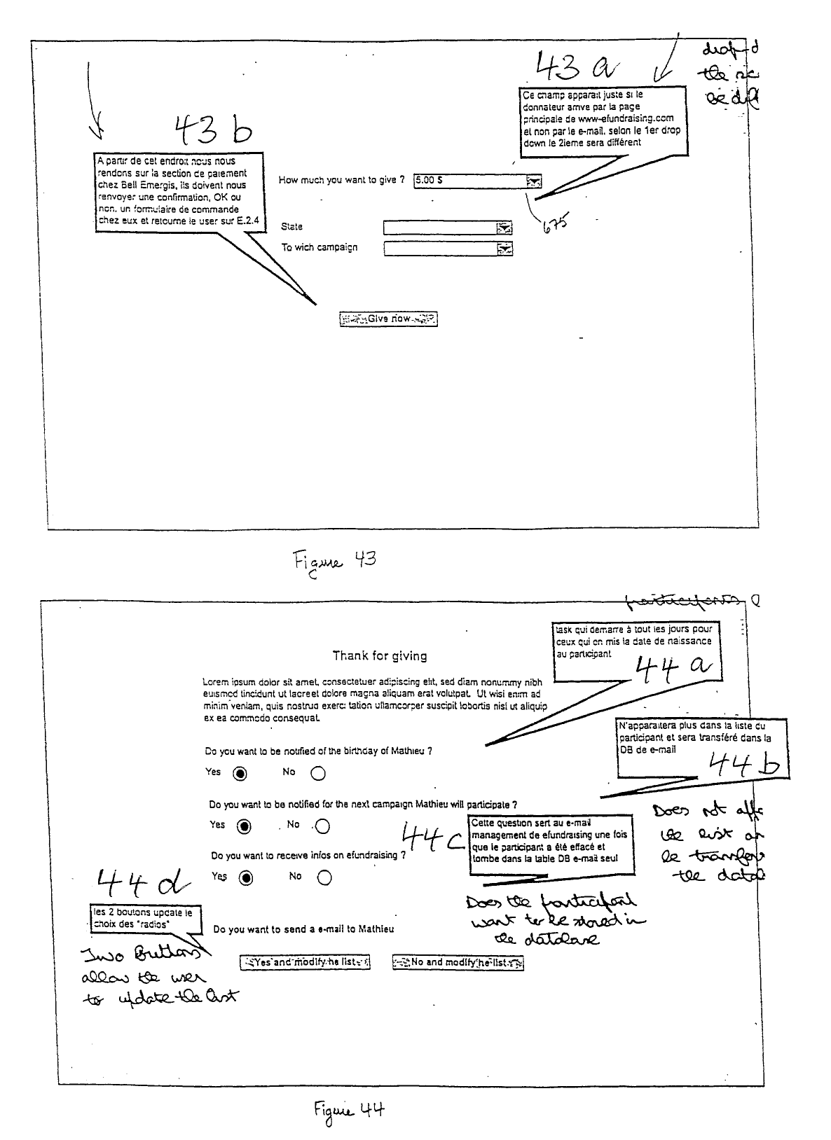

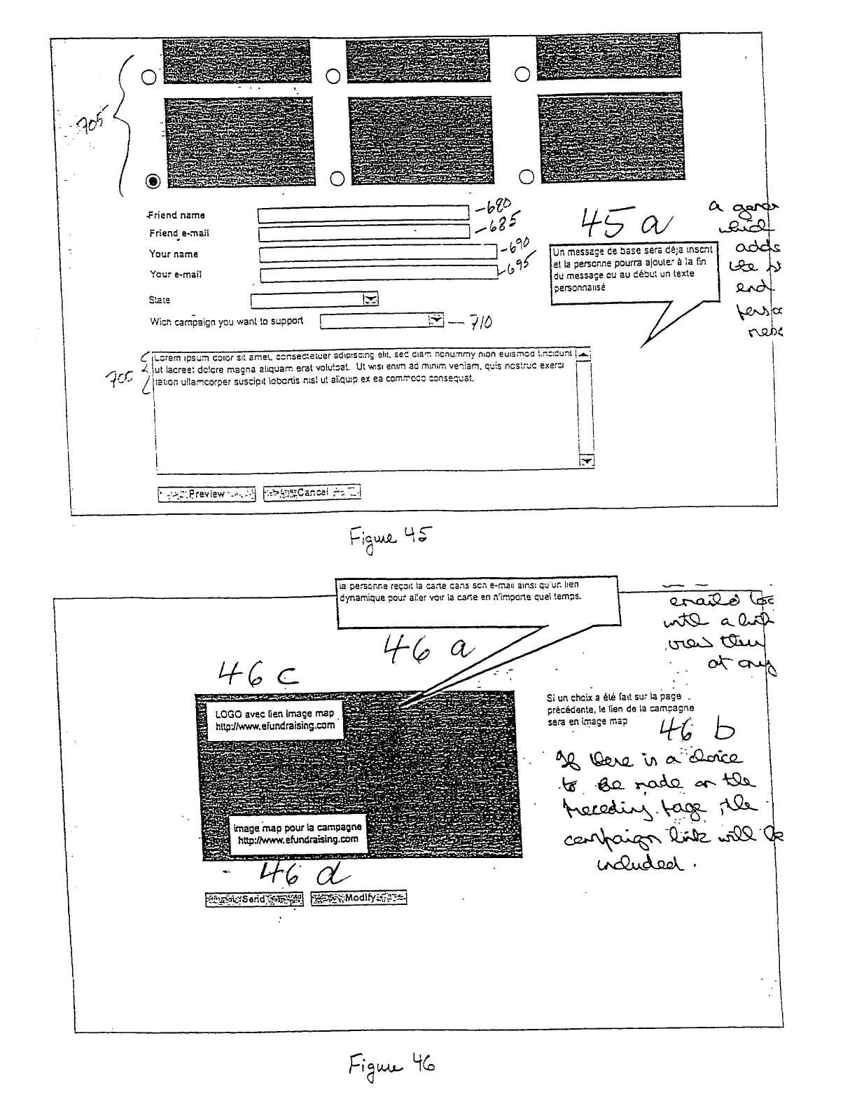

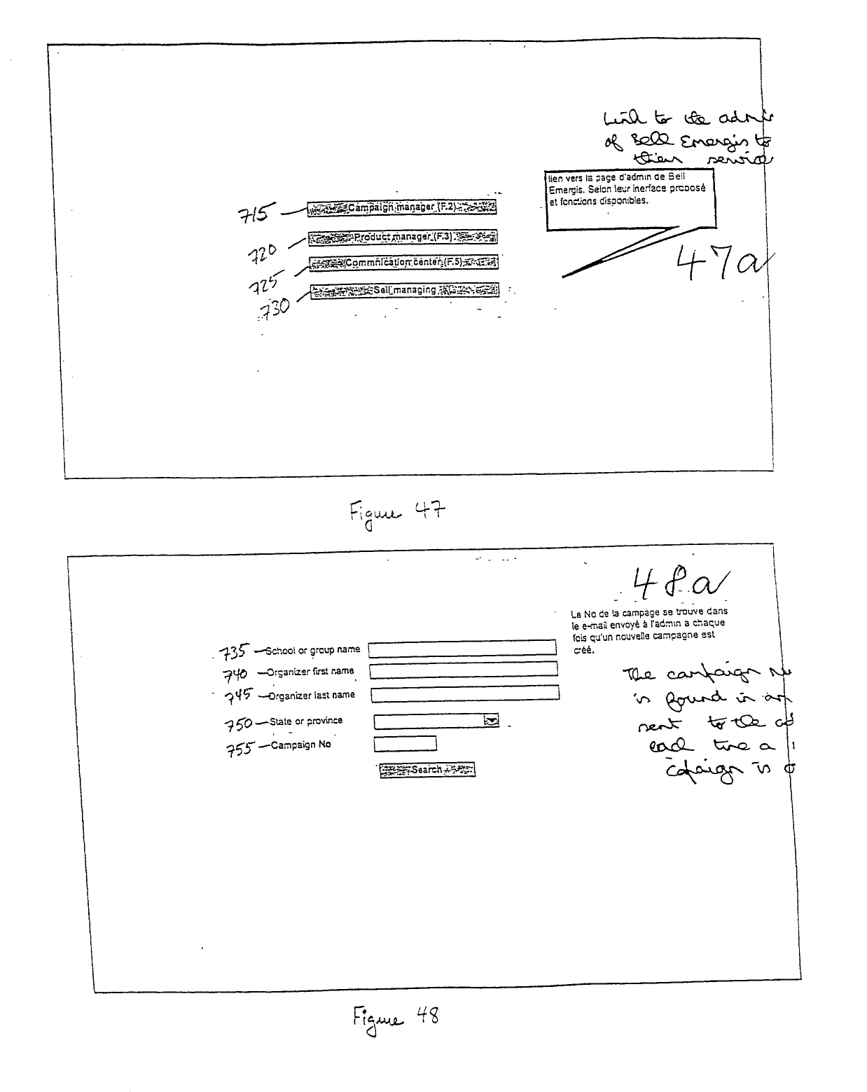

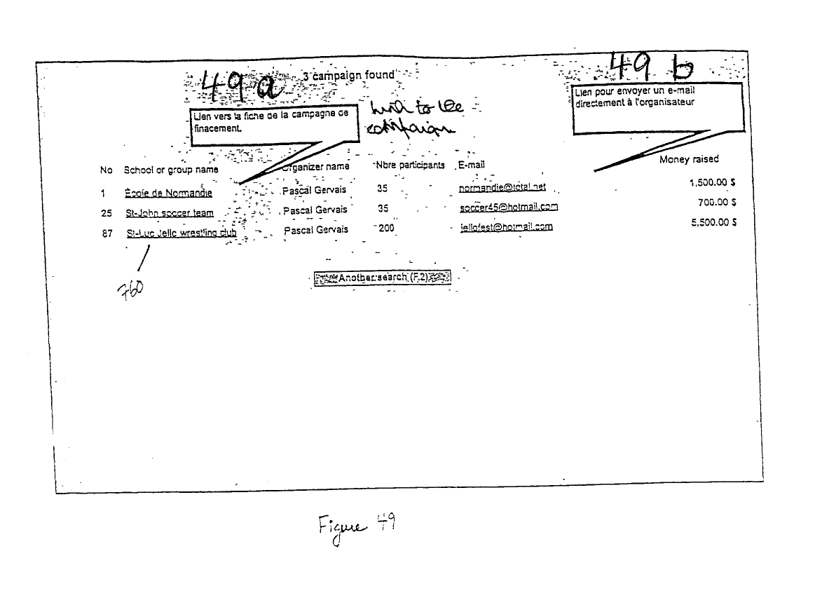

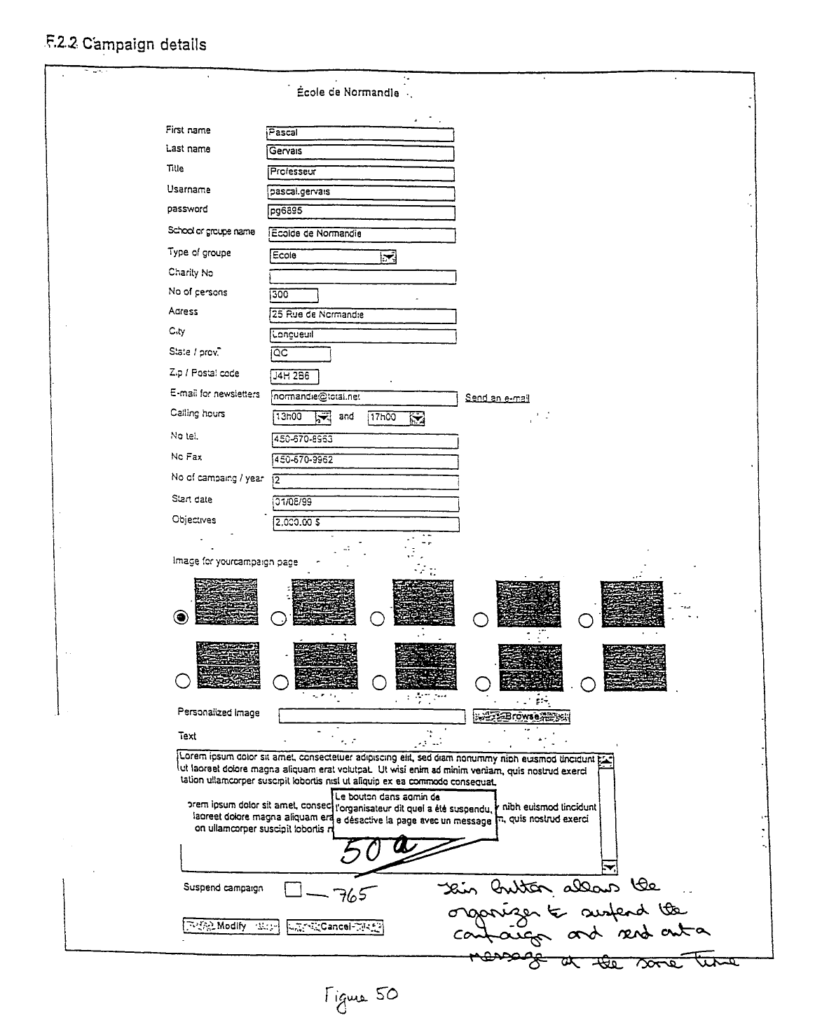

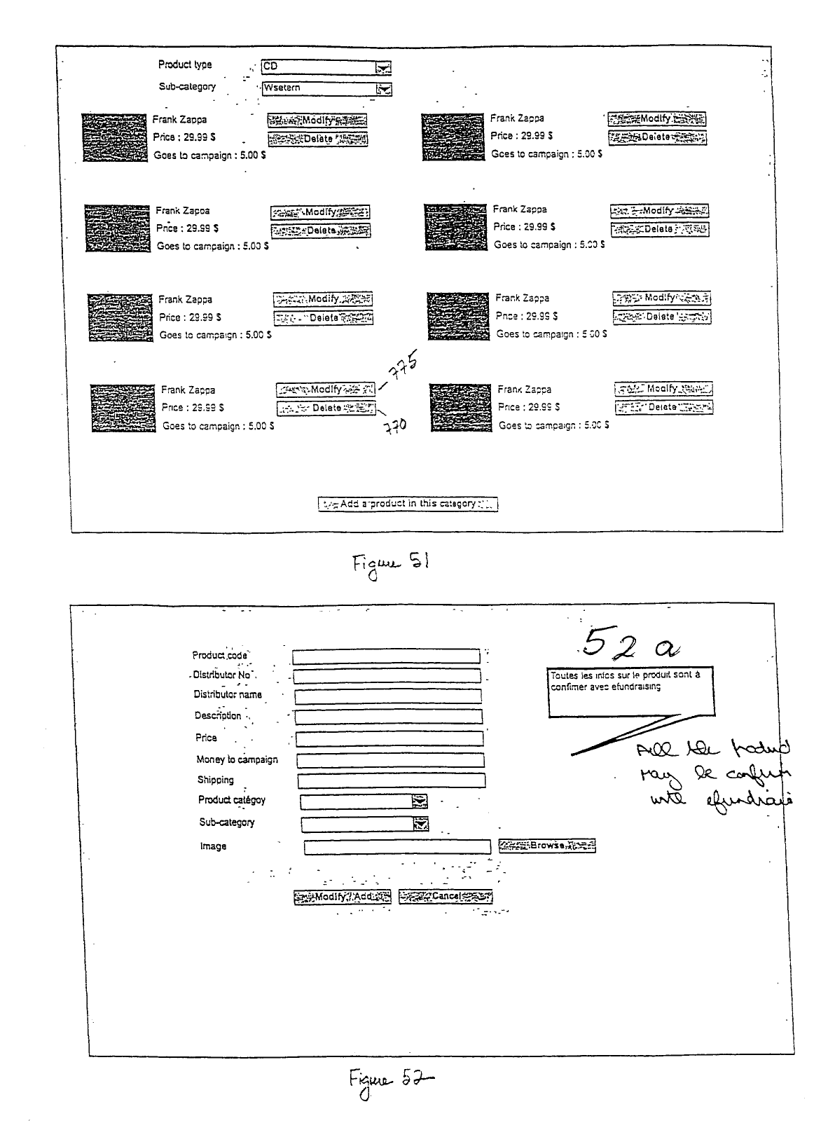

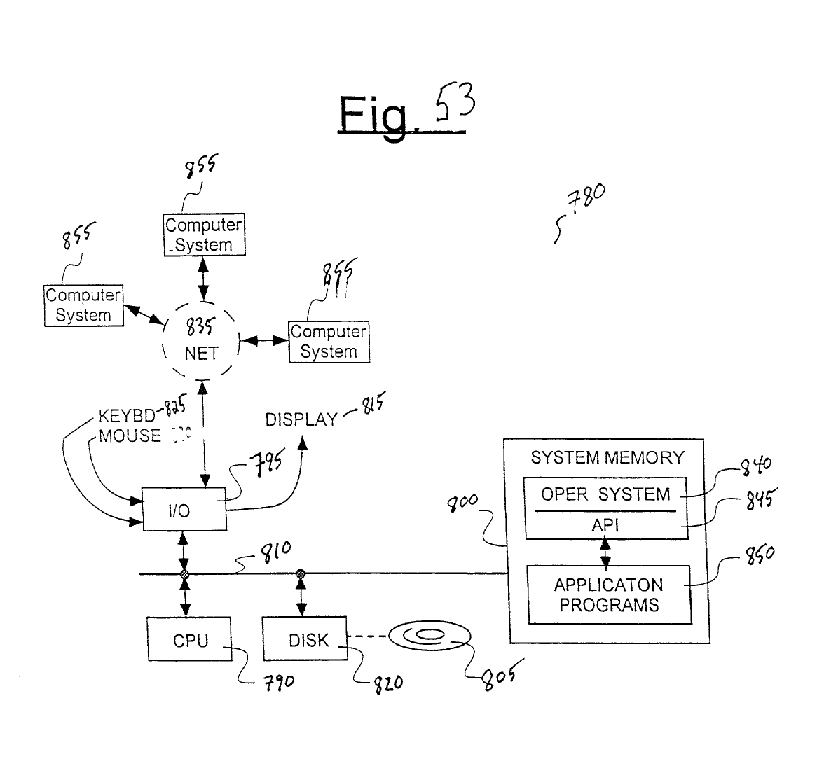

A Campaign Manager may set up more than one Campaign. Multiple Campaigns may even run simultaneously. FIG. 5 shows a Web page listing all of the campaigns that the Campaign Manager has created. Although just two campaigns are shown in FIG. 5, this page will list as many campaigns as the Campaign Manager has created for the Fundraising Organization. To create a new campaign, the Campaign Manager will select the create another campaign button 145.

At any time after registering with the Administrator, the Campaign Manager may create a new Campaign. This new Campaign may or may not be based on a previous Campaign. FIG. 6 shows the create new campaign screen. This screen provides the option of creating a new campaign based on a previous campaign. Pull-down menu 150 allows the Campaign Manager to select which previous campaign the new campaign should be based on. Creating a new Campaign based on a previous Campaign means that all the information entered while setting up a previous Campaign will be retrieved and used to create the new Campaign, without requiring the Campaign Manager to resubmit this information to the Administrator By selecting the yes button 155, a new Campaign will be created based on the previous Campaign listed in pull-down menu 150. If the no button 160 is selected, then the new Campaign is not based on a previous Campaign, and the Campaign Manager will be required to submit all the information necessary to launch a Campaign (such as the information asked for on the form shown in FIG. 4).

FIG. 7 shows a campaign registration form which is similar to the form described in FIG. 4. If the Campaign Manager decides to create a new Campaign based on a previous Campaign, information that is not likely to change from Campaign to Campaign may be retrieved from the Database and displayed in the campaign registration form. Examples of such information include the first and last name of the Campaign Manager, the type of group, the number of people participating in the Campaign, the official address of the Fundraising Organization, the Campaign Manager's email address, the Campaign Manager's fax number, and the text provided for the Home Page. This is shown in FIG. 7. Other information, which is likely to change from Campaign to Campaign (such as the start date of the Campaign and the amount of money that needs to be raised), may be left blank forth Campaign Manager to fill in.

If the Campaign Manager decides to create an entirely new Campaign, certain information can still be retrieved from the Database and provided in the appropriate boxes on the campaign registration form. For example, the official address of the Fundraising Organization can still be provided, as shown in FIG. 8.

Another feature of the present invention is the ability to allow the Campaign Manager to preview the Home Page before it is placed on the Web. FIG. 9 shows a preview of a Home Page, as seen by a Campaign Manager who is creating a new Campaign. The Home Page appears just as it would to a Potential Supporter viewing the Home Page from the Web. The Campaign start date and objectives (i.e., how much money the Fundraising Organization needs to raise) are both shown, along with the image that was selected above in FIG. 4. The text 130 entered in FIG. 4 is also shown. If the Campaign Manager wishes to modify any aspect of the Home Page, they may select the modify button 165.

Another aspect of setting up the Campaign is creating e-mail accounts for all Participants. Each Participant associated with a Campaign should receive their own e-mail account. The e-mail account may be web-based, or the account may utilize an SMTP or POP server. FIG. 10 shows the create new account screen, which requires the Campaign Manager to enter information about the Participant. This information will be stored in the Database. Examples of the kind of information about each Participant that could be stored include the name of the Participant (boxes 170 and 175), the Participant's birthday (box 180), and the Sub-Group to which the Participant should be added (pull-down menu 185). The creation of Sub-Groups will be discussed below.

Some Participants may have their own personal e-mail accounts; these may also be used in accordance with the present invention. When practicing the present invention, the Campaign Manager may find that Participants do not check the e-mail accounts associated with the Campaign as frequently as they check their own personal e-mail accounts. Therefore, it is desirable to send e-mail messages to Participants' personal e-mail accounts in addition to the e-mail accounts associated with the Campaign.

The e-mail account manager shown in FIG. 11 provides a way for the Campaign Manager to assign new Participant e-mail accounts and manage existing Participant e-mail accounts. The e-mail accounts in FIG. 11 are displayed according to the last name of the Participant. That is, all e-mail accounts belonging to Participants who have the same initial letter of their last name are shown on one screen. The screen shown in FIG. 11 shows three Participant e-mail accounts 190 belonging to Participants whose last name begins with the letter “A”. To view other Participant e-mail accounts, the Campaign Manager can select the letter in link 195 that corresponds to the first letter of the last name of the Participant whose e-mail account they would like to view. For example, by selecting box 200 and pressing button 205, Participant Peter Aztech will be removed from the Campaign. However, Peter Aztech's account will not be deleted. However, selecting box 200 and pressing button 210 will delete Peter Aztech (and the Potential Supporters associated with Peter Aztech) from the Database entirely. The number of Participant e-mail accounts and the manner in which they are displayed are for example only; any number can be maintained in accordance with the present invention, and there are a number of ways to display e-mail accounts that those skilled in the art will recognize. For example, all the e-mail accounts belonging to a particular Sub-Group could be displayed together. Or the e-mail accounts may be displayed according to their date of creation. Also, the kind of information displayed on the e-mail account manager screen (the name, birthday, and e-mail address of each Participant, as well as the Sub-Group that the Participant belongs to) is displayed by way of example only; any variety of information can be displayed in accordance with the present invention.

A Campaign Manager may choose to organize the Participants associated with a particular Campaign into Sub-Groups. For example, consider the case wherein all the students in a school are involved in a fundraising campaign for the school. It may be desirable for the Campaign Manager to create a Sub-Group that contains the first grade students, another Sub-Group that contains the second grade students, and so on. As will be discussed later, the Campaign Manager can then view the total sales made by an entire Sub-Group. FIG. 12 shows the Sub-Group manager screen, which allows a Campaign Manager to create and maintain Sub-Groups. The names 215 of the Sub-Groups shown in FIG. 12 are provided as 1A, 1B, 1C, etc., but this is for example only. Any names, numbers, or combination of words and numbers may be used in accordance with the present invention. By selecting link 220, the Campaign Manager can add Participants to or remove Participants from Sub-Group 1A. By selecting button 225, the Campaign Manager can create a new Sub-Group. Participants can belong to more than one Sub-Group.

Participants may occasionally forget their usernames and passwords. If this happens, the Campaign Manager can quickly provide this information to the Participants, because the Campaign Manager has access to the username and password associated with each Participant e-mail account.

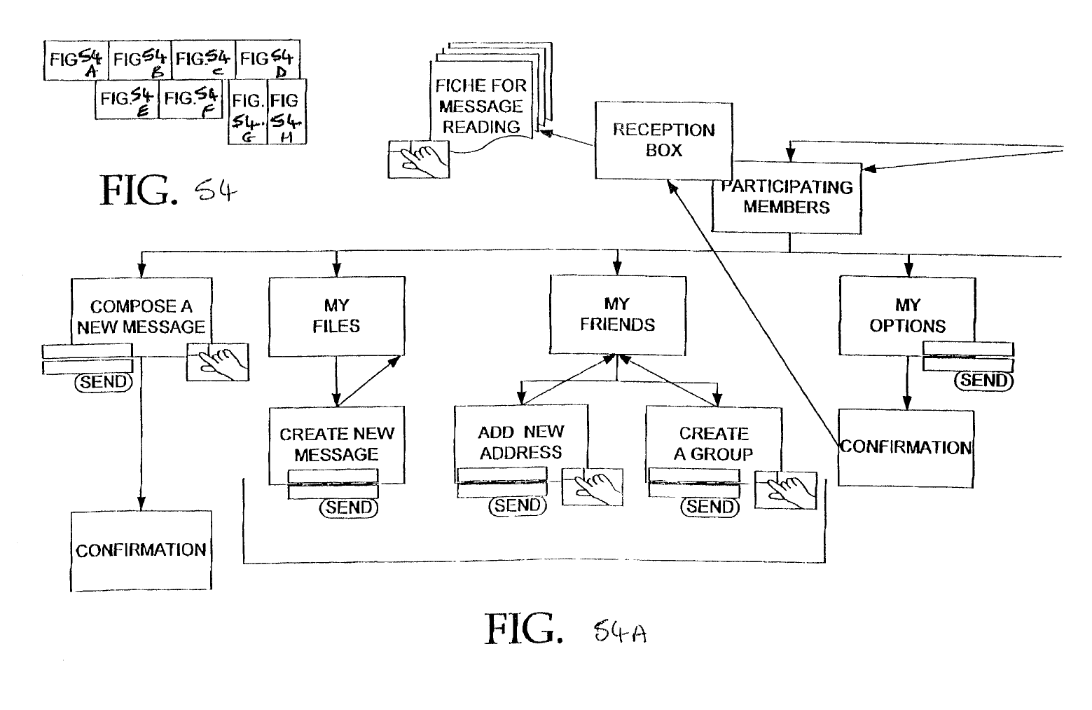

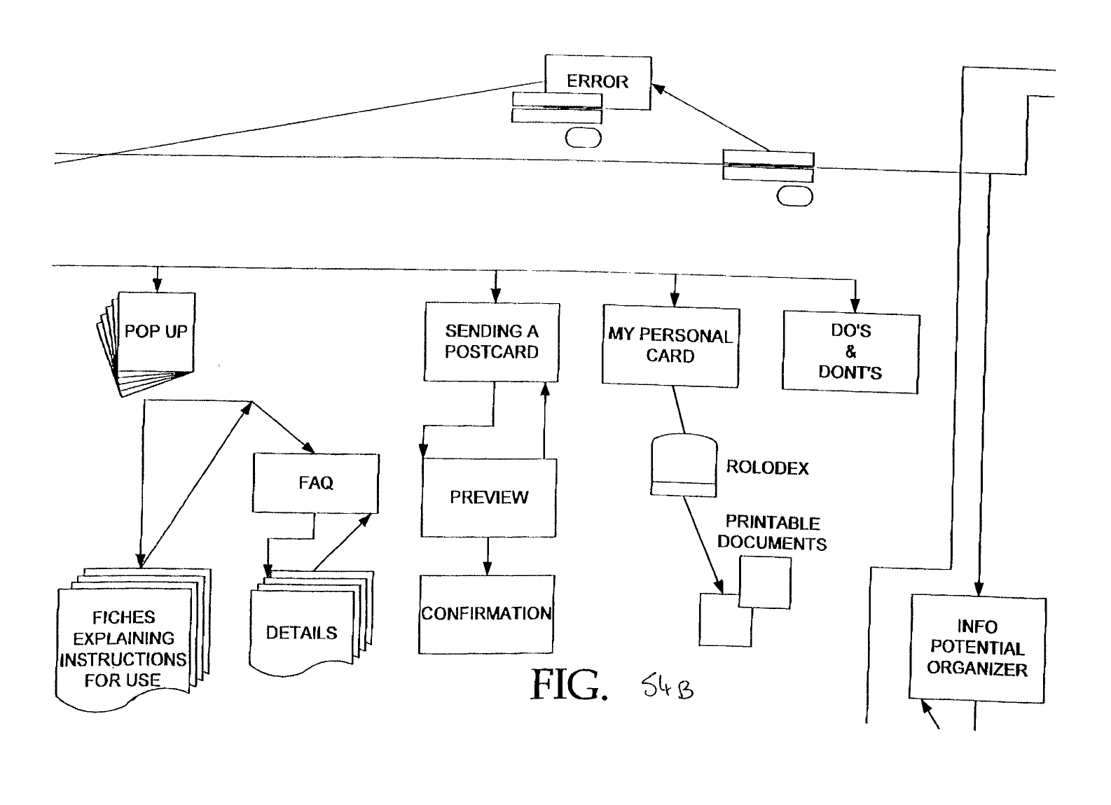

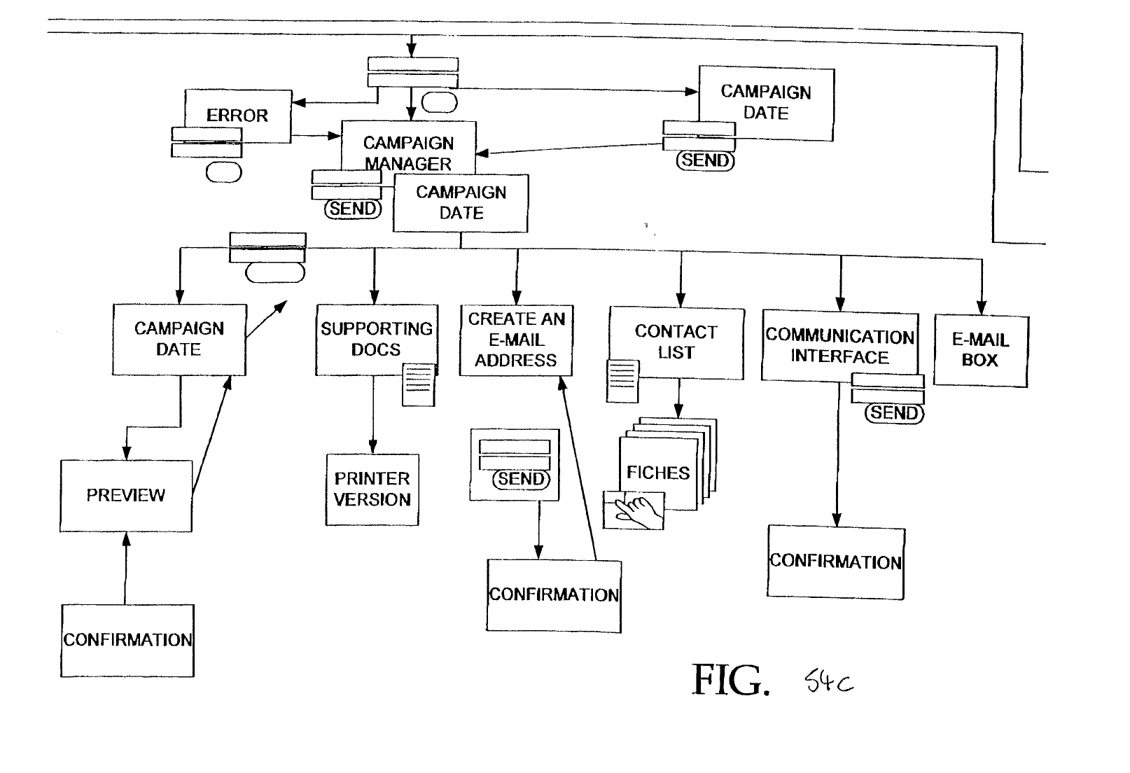

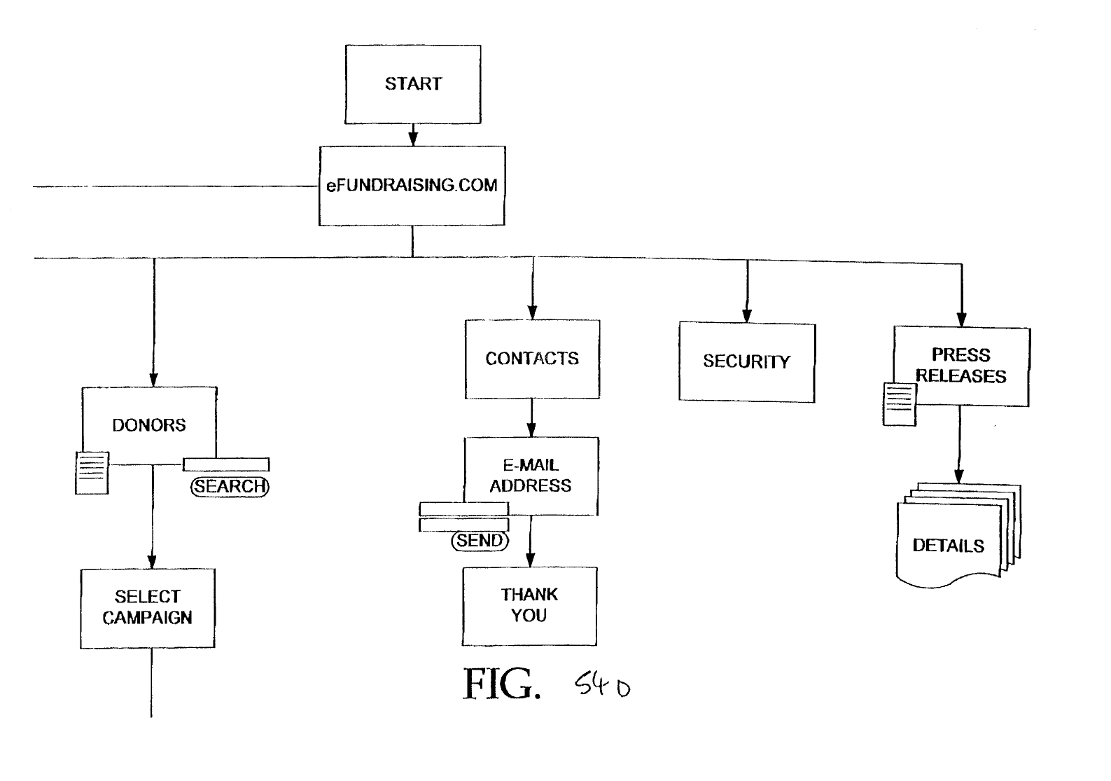

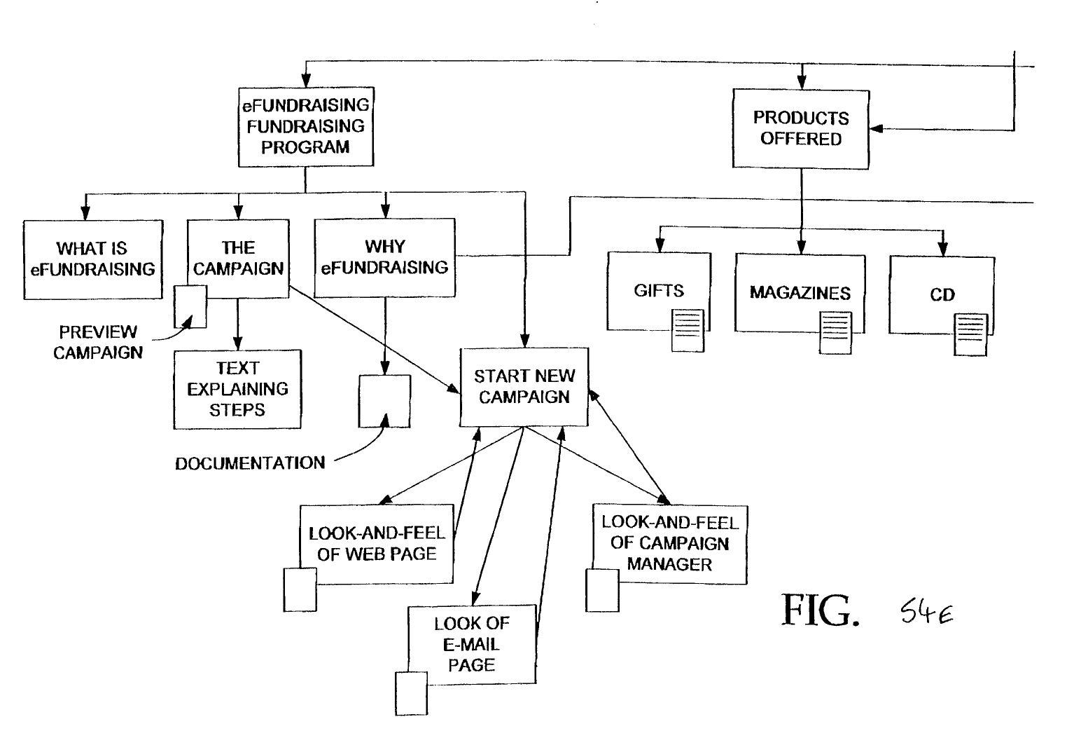

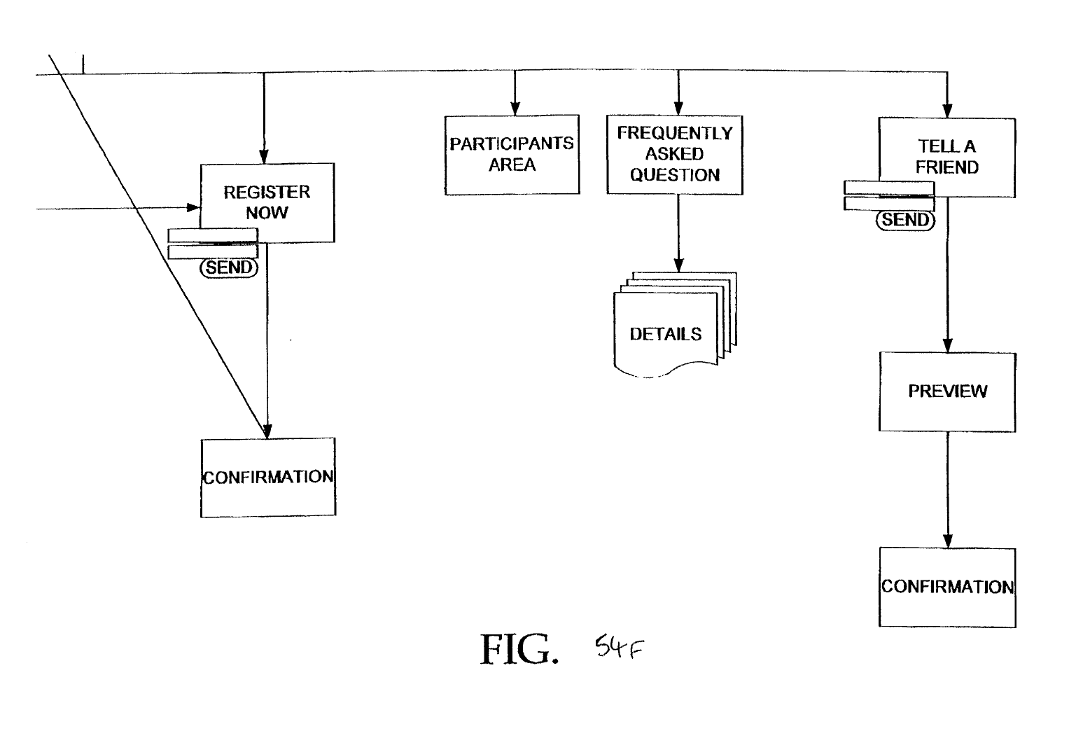

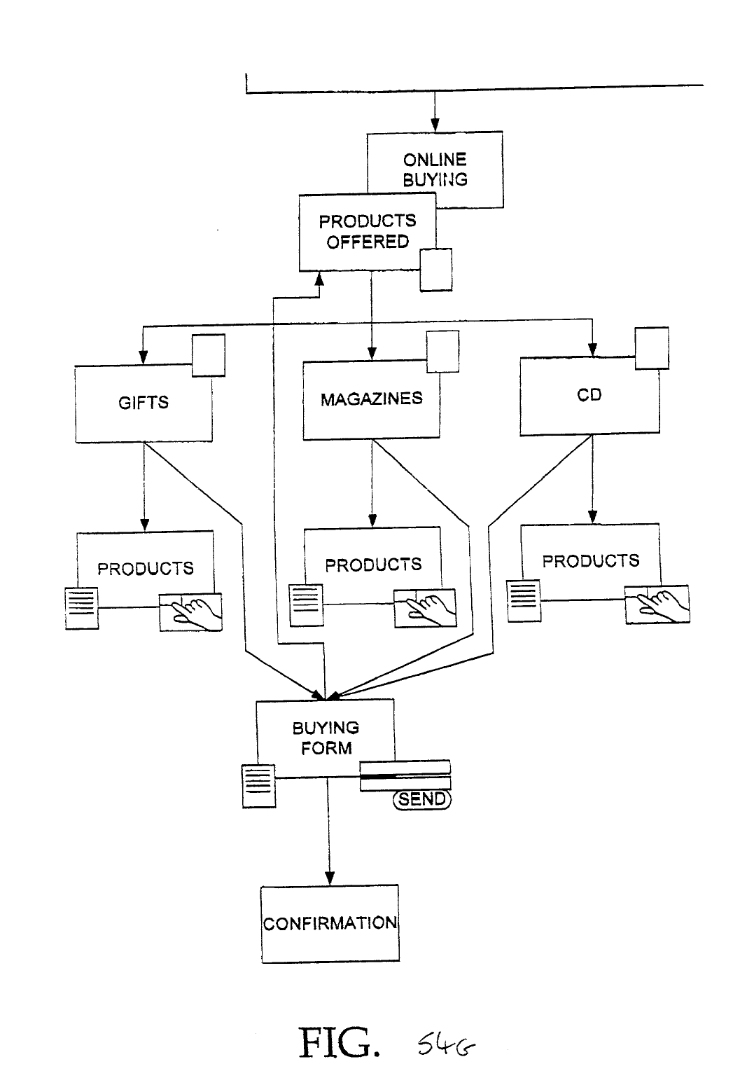

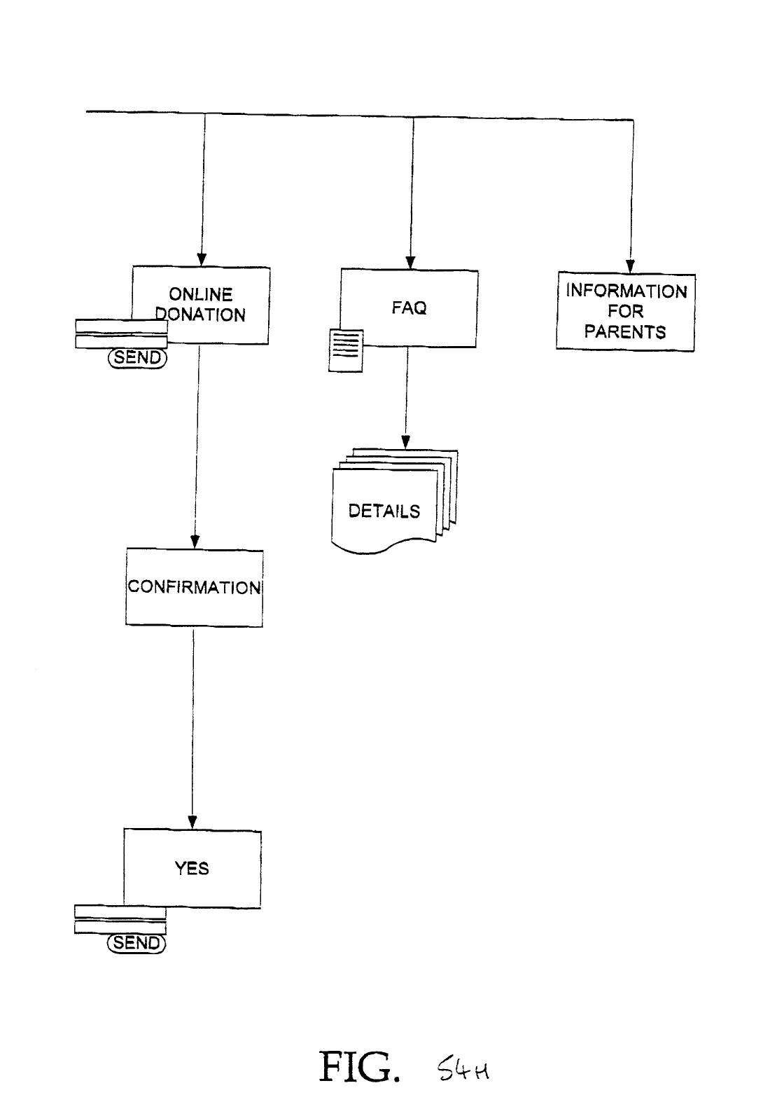

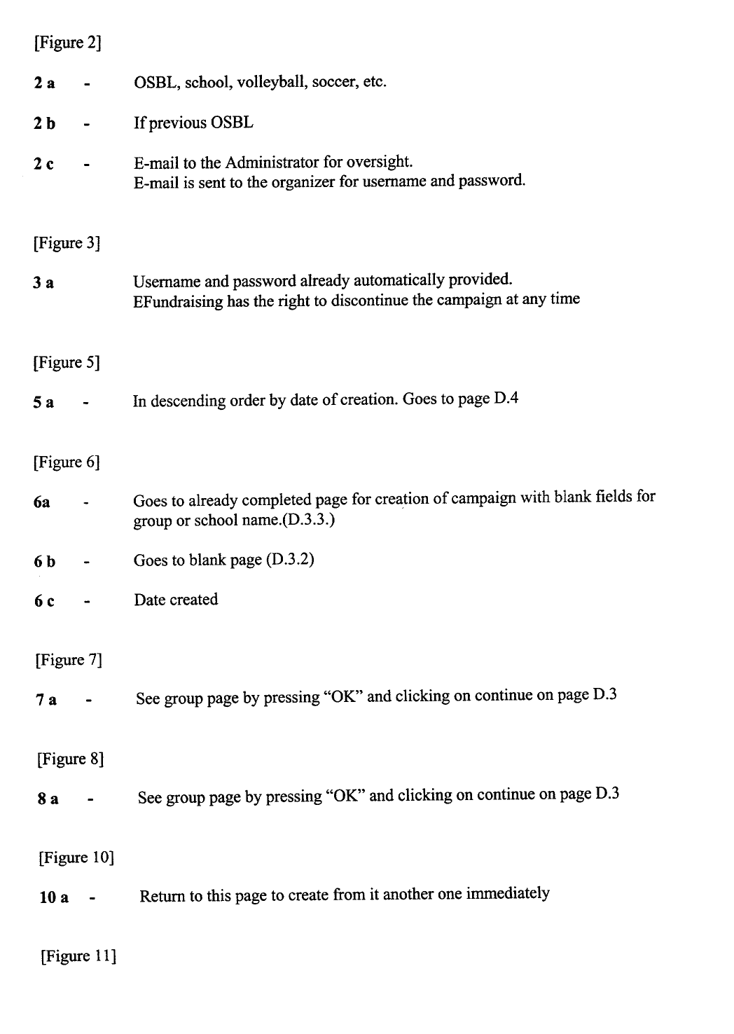

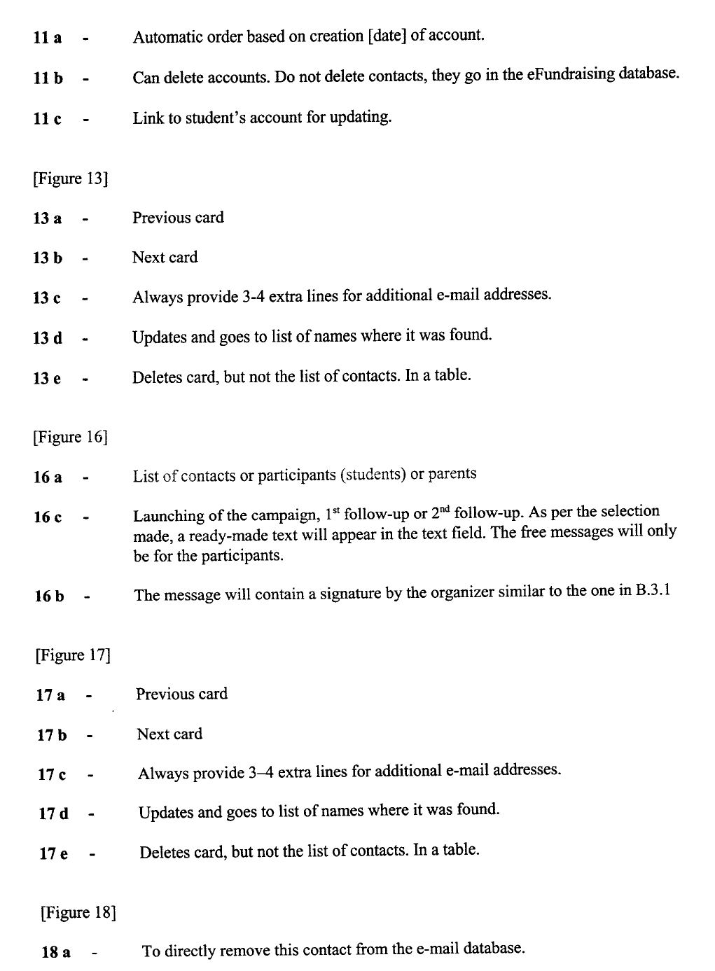

FIG. 13 shows a screen that allows the Campaign Manager to modify information about a Participant. The name of the Participant and the Participant's email address (either one issued by the Campaign Manager, or the Participant's personal e-mail address) are stored in accordance with an embodiment of the present invention. Other kinds of information—such as the Participant's birthday or Sub-Group—may also be stored. It may also be desirable to allow the Campaign Manager to disable the Participant's e-mail account. Such a feature might be useful, for example, if a Participant is using the e-mail account in an inappropriate fashion. This might be accomplished by selecting box 230. The Send E-mail link 235 allows the Campaign Manager to send an e-mail to the Participant.

Every time a Campaign is created, the Participants associated with that Campaign are maintained in the Database. When creating a new Campaign, a Campaign Manager may want to select Participants from Campaigns that have been previously created. This can be accomplished by searching the Database for all Participants that meet certain criteria, and adding those Participants to the Database. For example, suppose an elementary school having 1st through 6th grades sets up a Campaign annually. When creating a new Campaign for the school, the Campaign Manager will be able to save a lot of time by searching for all Participants who were in the 1st through 5th grades the previous year (i.e., the students who are still attending that school), and adding those students to the new Campaign.

FIG. 14 shows a screen that allows a Campaign Manager to search the Database for Participants' e-mail accounts. The Campaign Manager can fill in as much or as little information as she wishes about the Participants. The first letter of the last name of a Participant is shown in box 240; entering such a search would retrieve the e-mail accounts of all the Participants whose last name begins with the letter “A”. Alternatively, the Campaign Manager could enter other information, such as the Participant's birthday (box 245), the Sub-Group (or Sub-Groups) to which the Participant belongs (pull-down menu 250), whether the Participant's e-mail account has been blocked (box 255), the Participant's username (box 260) or password (box 265), or Potential Supporters that the Participant has found (270). In the example discussed above, the Campaign Manager of the school could search for all Participants who were in Sub-Groups 1 through 5 (representing 1st through 5th grades) from the previous year's Campaign. In accordance with the present invention, the Campaign Manager could also be allowed to search the Database for the e-mail account belonging to a Potential Supporter or group of Potential Supporters.

The results of a search are displayed in the search screen shown in FIG. 15. By clicking on button 275, the Campaign Manager adds those students who have been selected (by selecting box 280) to the new Campaign. In the Database, the Potential Supporters found by a Participant are linked to that Participant. So adding a Participant to a Campaign also adds the Potential Supporters associated with that Participant to that Campaign. Alternatively, the Campaign Manager may search directly for Potential Supporters to add to a Campaign, in which case the results displayed in FIG. 15 would show Potential Supporters. The Campaign Manager may also use the search screen to find Participants (or Potential Supporters) to delete from the Database. By selecting box 280 and pressing button 285, the Campaign Manager can delete a Participant (or Potential Supporter) from the Database.

Collecting E-Mail Addresses of Potential Supporters

It is preferable to involve Participants in the process of collecting e-mail addresses of Potential Supporters, although the Campaign Manager may also collect them. The best way to get Participants involved in collecting e-mail addresses of Potential Supporters is to frequently send e-mail messages to Participants. Examples of such e-mail messages include:

Messages sent several weeks before the Campaign start date, letting Participants know that there is an upcoming Campaign.

Messages sent a few days before the Campaign start date, telling Participants to start thinking about what Potential Supporters they can find.

Messages sent at the start of the Campaign, asking Participants to begin collecting e-mail addresses of Potential Supporters.

FIG. 16 shows a screen used to compose an e-mail message to a Participant.

Pull-down menu 290 allows the Campaign Manager to select who will receive the e-mail message. The pull-down menu 290 may list all the Sub-Groups that have been created. This way, the Campaign Manager can compose one e-mail message that will be sent to all Participants in the Sub-Group. Alternatively, pull-down menu 290 may list the e-mail addresses of all Participants. In this case, the Campaign Manager will have to compose a separate e-mail message for each Participant. Pull-down menu 295 identifies what kind of message that is being sent. There are several types of messages that a Campaign Manager may send to a Participant. As discussed above, a Campaign Manager may send a message saying that a new Campaign is about to begin in a week, so the Participant should start thinking about Potential Supporters that she can find. This might be termed a “Pre-Campaign message”. A Campaign Manager may also send a message saying that the Campaign is beginning. This might be termed the “Campaign Starting message”. Or a Campaign Manager may send a message saying that the Campaign is about to end, so the Participant should hurry and find as many Potential Supporters as she can. This might be termed the “Hurry—Campaign Ending message”. There are many other examples of messages that the Campaign Manager might send to a Participant in accordance with the present invention. All of these kinds of messages may be listed in pull-down menu 295, which might appear as the Subject line on the e-mail message received by the Participant. The text of the e-mail message appears in box 300.

The e-mail account associated with a Participant also includes information about all the Potential Supporters that the Participant has found. The modify account screen shown in FIG. 17 allows the Campaign Manager to modify information about a Participant's e-mail account. For example, when the Participant submits a list of Potential Supporters that she has found, the Campaign Manager can enter those Potential Supporters into the Database using this screen. It is necessary to collect the e-mail address of a Potential Supporter (box 305) in accordance with the present invention, since the Solicitation Messages are sent via e-mail. Other kinds of information that may be important to collect about each Potential Supporter includes the Participant's gender (box 310), name (boxes 315 and 320), and relationship to the Participant (box 325). Other information may also be collected in accordance with the present invention. To delete the Participant's account, but not the list of Potential Supporters associated with the account, the Campaign Manager should click on button 330. Instead of having the Campaign Manager enter the list of Potential Supporters into the Database, the Participants may be allowed to add the Potential Supporters themselves (from a different area of the Web site, since Participants are not allowed into the Campaign Manager section).

One issue that may be encountered while practicing the present invention is that Potential Supporters might give nonfunctional e-mail addresses. When this happens, the Administrator will preferably notify the Campaign Manager about these nonfunctional e-mail addresses. One way to notify the Campaign Manager is shown in FIG. 18. This screen shows two Participants (Mathieu Aberdeen and Fred Bellerose), and all the nonfunctional e-mail addresses associated with each. This is just one way to display the nonfunctional e-mail addresses; other methods of displaying the nonfunctional e-mail addresses will be recognized by those skilled in the art. When a Campaign Manager becomes aware of the nonfunctional e-mail addresses, they may choose to simply delete the Potential Supporters from the Database. This is accomplished by selecting box 335 and pressing button 340. Alternatively, the Campaign Manager may choose to send an alert to the Participant who found the Potential Supporter, thereby giving the Participant an opportunity to verify the Potential Supporter's e-mail address before deleting it. This is accomplished by selecting box 345 and pressing button 350.

Sending Solicitation Messages to Potential Supporters

After Potential Supporters' e-mail addresses have been collected, the Campaign Manager may compose an initial Solicitation Message to send to all Potential Supporters. The content of such a message is shown in FIG. 37 and is discussed later. Following an initial Solicitation Message, the Campaign Manager may want to sent follow-up Solicitation Messages at different stages of the Campaign.

The Campaign Manager is not required to send the Solicitation Messages. Participants may also compose and send their own Solicitation Messages.

Managing the Campaign

After Participants collect e-mail addresses and the Campaign begins, the Campaign Manager will likely want to find out certain information—like the amount of total Sales, the Sub-Groups that are performing well, the kinds of products that are most popular with Supporters, etc. This information can then be used to modify the Campaign so as to increase the amount of total sales generated.

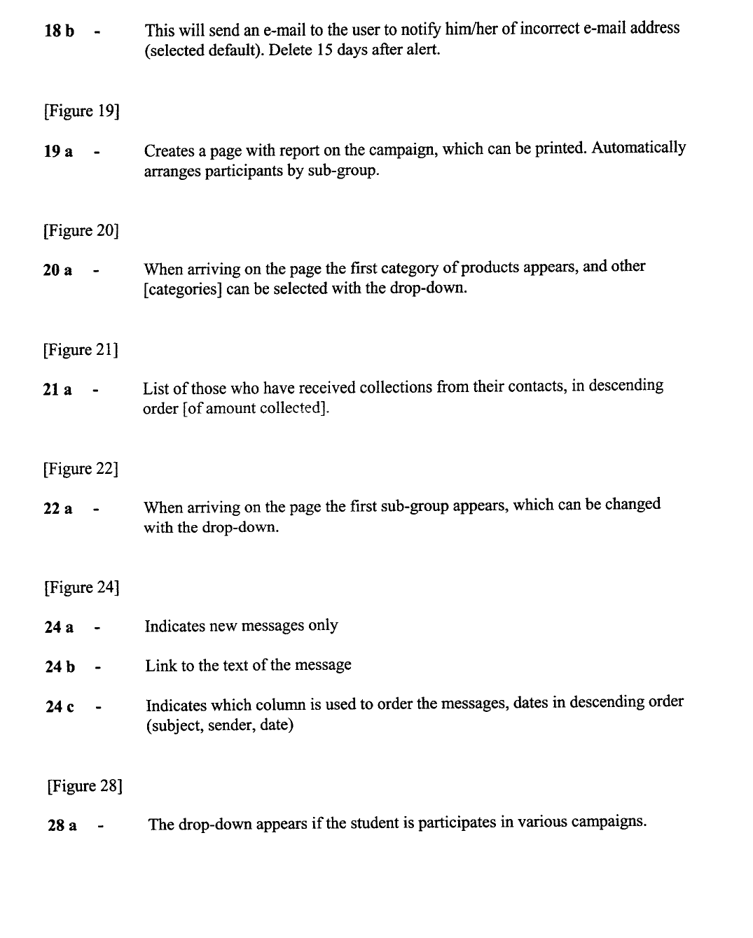

FIG. 19 shows a page which the Campaign Manager can access to get information about how the Campaign is progressing. By selecting button 355, the Campaign Manager can see a list of all the products sold during the Campaign, which will enable the Campaign Manager to offer more of the more popular products. (As will be discussed later, the Campaign Manager is able to choose which products are displayed in accordance with a particular Campaign.) For example, if a number of Supporters buy music CDs, but not many Supporters buy candy, then the Campaign Manager may choose to offer a wider selection of music CDs (more artists, genres, etc.), and less candy. By selecting button 360, the Campaign Manager can see a list of the total sales attributable to each Participant. Similarly, by selecting button 365, the Campaign Manager can see a list of the total sales attributable to each Sub-Group. The Campaign Manager may choose to contact (via e-mail or otherwise) those Participants or Sub-Groups who are not performing well (or even those who are performing well), to motivate them. The methods which can be used to motivate Participants and Sub-Groups will be discussed later. By selecting button 370, the Campaign Manager can create a report that summarizes the Campaign's progress. This report may include statistics about, for example, total sales, the highest and lowest selling Participants or Sub-Groups, the most popular products, or any number of other statistics.

FIG. 20 shows a screen that the Campaign Manager uses to see statistics about the products that have been sold during a Campaign. Many different kinds of products can be offered. Examples include music CDs, candy, magazines, etc. (As will be explained later, the Administrator usually provides the selection of products that the Campaign Manager chooses from. The Administrator may obtain some of these products from an outside vendor. The Fundraising Organization itself may also provide products to sell.) Pull-down menu 375 allows the Campaign Manager to select the kind of product which she would like to see statistics about. In FIG. 20, the Campaign Manager has selected CDs. Pictures 380 of the CDs are displayed, along with the number of copies of each CD that has been sold during the Campaign. As shown in FIG. 20, two sets of statistics provided. Statistic 385 refers to the number of CDs that have been sold during the Campaign. Statistic 390 refers to the total sales made during the Campaign. Statistic 395 represents the total sales in gross. Statistic 400 represents the net profit to the Fundraising Organization. So, as shown in FIG. 20, $225 of CDs have been sold during the Campaign, and this has netted $20 for the Fundraising Organization. Also, $8,250 of total sales (counting all products) have been made during the Campaign, and this has netted $1,500 for the Fundraising Organization.

The ratio of total sales to net profit for the Fundraising Organization depends on the method used to supply the products. The products may be provided by the Administrator. One way for the Administrator to supply products for the Campaigns is to enter into a partnership with vendors, preferably those involved in e-commerce. Under this approach, the vendor provides a picture and description of a product to the Administrator. The Administrator creates a series of Web pages displaying all the products that can be purchased by Potential Supporters. The Campaign Manager selects which products are to be displayed in conjunction with a particular Campaign. When a Supporter purchases a product, the Administrator collects the money for the product. There are many ways that the money can be collected: an online credit card transaction, a check sent by regular mail, etc. The money is preferably stored in a trust account in a bank. However, the Administrator may maintain the money in a variety of different ways—for example, a regular bank account. The vendor ships the product directly to the Supporter. The vendor then invoices the Administrator for a certain percentage (preferably anywhere from 40-65%) of the purchase price. A certain percentage (preferably around 10%) of the purchase price is kept by the Administrator. The remainder (preferably around 25-50%) is sent to the Fundraising Organization.

The Administrator may already be a vendor involved in e-commerce. In that case, when a Supporter purchases a product, the Administrator would collect the money and maintain a higher percentage (preferably around 50-75%) than if the Administrator weren't already an e-commerce vendor capable of supplying products.

FIG. 21 shows a screen that the Campaign Manager can view to see statistics about the Participants involved in the Campaign. The Campaign Manager is able to see sales statistics for each Participant (three Participants are shown in FIG. 21 for example only). The total amount collected (i.e., the net profit to the Fundraising Organization; statistic 405) is shown for each Participant, although the total amount sold (in gross) could also be shown.

FIG. 22 shows a screen that the Campaign Manager can view to see statistics about the Sub-Groups involved in the Campaign. Instead of seeing sales statistics for all Participants, the screen shown in FIG. 22 allows the Campaign Manager to see sales statistics for all Participants in one Sub-Group. Alternatively, this screen could show the statistics for the entire Sub-Group, without listing individual Participants. A pull-down menu 410 allows the Campaign Manager to select which Sub-Group she would like to see statistics for.

The Invention as Experienced by the Participant

FIG. 23 shows how a Participant would practice the present invention. The Participant's involvement comprises the following steps:

1. Collecting e-mail addresses from Potential Supporters;

2. Sending Solicitation Messages to Potential Supporters; and

3. Monitoring Sales.

Collecting e-mail addresses

There are a number of ways for Participants to find Potential Supporters. The most effective way is for Participants to directly ask friends and relatives for their e-mail addresses. Alternatively, the Campaign Manager may send a letter to people who may be interested in supporting the Campaign. (For example, if the Fundraising Organization is a school, the Campaign Manager may send a letter to all people living within the community, telling them about the Home Page and the Campaign.) More elaborate and costly methods of finding Potential Supporters are also within the scope of the present invention. For example, a Campaign Manager may purchase a list of email addresses from a marketing company.

The e-mail addresses collected by Participants may be written down on a piece of paper and given to the Campaign Manager, who would then enter the Potential Supporters into the Database, as shown in FIG. 17. Alternatively, the Participants may enter the names of Potential Supporters directly into the Database.

Send Solicitation Messages to Potential Supporters

As described above, the Campaign Manager usually sends an initial Solicitation Message and several follow-up Solicitation Messages to all Potential Supporters. It would also be advantageous for the Participants to be able to send initial or follow-up Solicitation Messages to the Potential Supporters that they found, or respond to e-mail messages sent by Potential Supporters.

Participants can send messages to or reply to messages from Potential Supporters (or other individuals) through an electronic mailbox. One aspect of the present invention is to provide an electronic mailbox for each Participant. The electronic mailbox discussed in FIGS. 24 through 35 is Web-based. However, e-mail accounts that are not Web-based (such as e-mail accounts that use SMTP or POP servers) may also be used in accordance with the present invention. In addition to sending messages to Potential Supporters, Participants may use an electronic mailbox to send messages to and receive messages from the Campaign Manager or other Participants. The mailbox has all the well-known features typically associated with electronic mailboxes: for example, the ability to read messages, compose new messages, reply to messages, forward messages, arrange messages into different “folders” within the mailbox (for example, all deleted e-mails in one folder), arrange the messages within a folder according to particular characteristics (such as date received, name of sender, etc.), and other well-known features.

FIG. 24 shows a sample in box. This folder within the electronic mailbox stores e-mail messages that have been received by the Participant, and displays them in order of date received, name of sender, subject, etc.

FIG. 25 shows a sample e-mail message that can be read by a Participant using her electronic mailbox. The format of the message is similar to the format of a well-known e-mail message. Specifically, the message includes the date, the name and e-mail address of the person sending the message (the Sender), the subject, and the name and e-mail address of the Participant (the person receiving the message).

FIG. 26 shows a screen that a Participant may use to respond to an e-mail message. By checking box 415, a signature message is appended to whatever text the Participant types into box 420. This signature message can include a link to the Home Page, which is especially desirable if the Participant is responding to a message sent by a Supporter or Potential Supporter.

FIG. 27 shows a screen that a Participant may use to forward an e-mail message.

FIG. 28 shows a screen that a Participant may use to compose a new e-mail message. As described above, the signature prepared by a Participant can include a link to the Fundraising Organization's Home Page. This works nicely if the Participant is only associated with one Campaign. If a Participant is a member of multiple Fundraising Organizations or Campaigns, box 425 and pull-down menu 430 allow the Participant to choose which link appears in the e-mail message. For example, if the Participant is a member of three separate Fundraising Organizations who are running online Campaigns, links to the Home Page associated with each Fundraising Organization will appear in the pull-down menu 430. If the Participant selects one of these links and also selects box 425, a link to the selected Fundraising Organization's Home Page will appear in the e-mail message. Alternatively, if the Participant selects box 435, links to all Home Pages associated with the Participant will appear in the e-mail message.

FIG. 29 shows how a signature file can be created by a Participant. The Participant's first and last name are entered in boxes 440 and 445. The Participant can type a message into box 450. If the Participant chooses to create a link to a Home Page in the signature file, it could be entered in box 450.

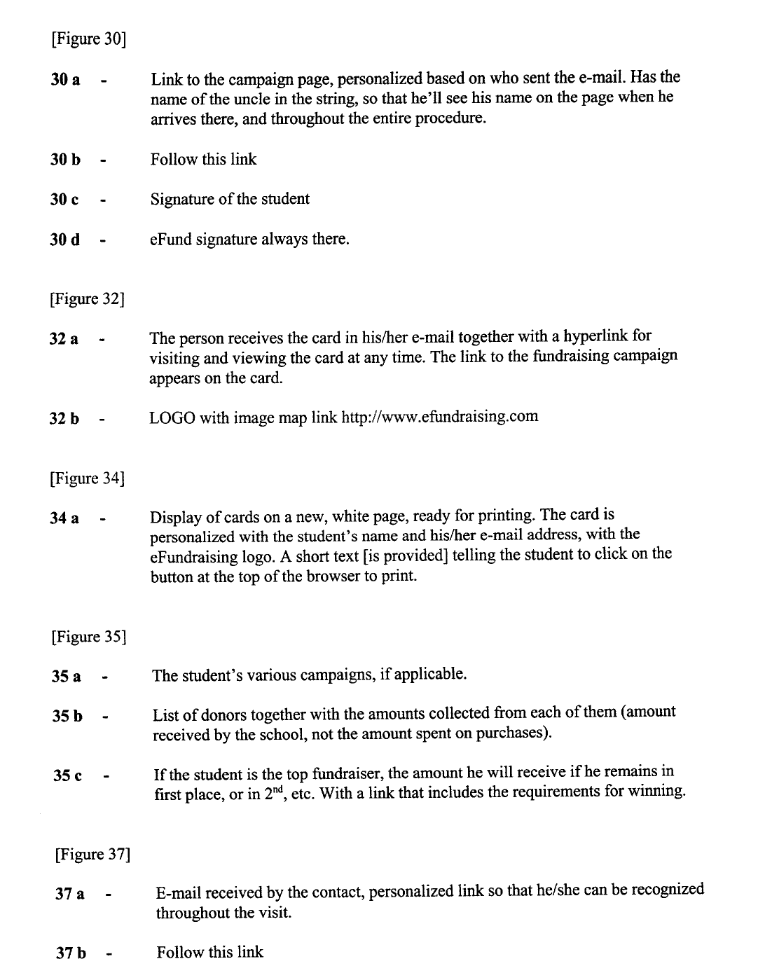

FIG. 30 shows a sample signature as it appears in an e-mail message. It is preferable to include a link 455 to the Home Page. A link 460 to the Administrator Home Page, the name of the Participant, a message created by the Participant, and a slogan associated with the Administrator are examples of features that may also be provided.

In addition to sending a regular e-mail message, the Participant may also send an electronic card (e-card). The Participant may send such a card to any individual, but the cards are preferably sent to Potential Supporters or Supporters. FIG. 31 shows the screen that appears when a Participant creates such an e-card. The Participant can simply select one of the images 465 to send. These images can be created by the Administrator. Alternatively, the Participant may be allowed to upload an image from her personal computer to send in the e-card. The Participant's name and e-mail address automatically appear in boxes 470 and 475. The friend's name and e-mail address (boxes 480 and 485, respectively) can be filled in by the Participant. Text 490 can be composed by the Participant. The pull-down menu 495 allows the Participant to insert links to one or more Home Pages. The preview button 500 allows the Participant to preview the e-card before sending.

FIG. 32 shows an example of what the Participant sees on the computer screen if she previews the e-card. The selected image, the link to one or more Home Pages, and the text written by the Participant all appear just as the person who receives the message would see them.

There are ways for Participants to publicize information about the Campaign other than by sending e-mail messages. Another feature of the electronic mailbox is the ability for a Participant to create “business cards” that can be printed and distributed to Potential Supporters. FIG. 33 shows six sample formats of business cards, which can be created by the Administrator. Alternatively, the Participant may be allowed to create her own business cards. Each business card may contain the Participant's name, e-mail address, a link to one or more Home Pages, a logo associated with the Administrator, and other relevant information. In FIG. 33, the Participant can select which business card she wants by clicking on the appropriate button 505.

FIG. 34 shows several personalized business cards displayed on one page with a white background. The cards can then be printed, cut apart, and distributed to Potential Supporters or other individuals.

Monitor Sales

One aspect of the present invention involves associating a purchase or contribution made by a Supporter with a Participant. That is, when a Supporter makes a purchase in support of a Campaign, she is given the opportunity to associate that purchase with a Participant. When a purchase is associated with a Participant, that Participant is said to have made a Sale.

After the Campaign begins, Participants will want to monitor their total Sales, and possibly their rank within the Campaign (i.e., how many Participants have made more total Sales). In accordance with the present invention, the Administrator may provide rewards for the top sellers associated with each Campaign. These rewards may alternatively be provided by the Fundraising Organization directly. Rewards may include:

1. Prizes for the Participant with the most total Sales.

2. Prizes for the Sub-Group with the most total Sales.

3. Prizes for every Participant who reaches a certain threshold of Sales.

By providing the Participants with an opportunity to monitor their total Sales and their rank within the Campaign, the Participants are given more of an incentive to find more Potential Supporters.

FIG. 35 shows a part of the electronic mailbox that allows a Participant to view her total Sales. If the Participant is involved in multiple Campaigns, the pull-down menu 510 allows the Participant to select which Campaign she would like to see statistics for. The total Sales made by the Participant 515 are shown, as are the total Sales made by the Sub-Group 520 to which the Participant belongs. Alternatively, the total Sales made during the Campaign could be displayed. How many Sales the Participant has made compared with the rest of the Participants in the Campaign is given by the rank 525. Similarly, how many Sales the Sub-Group has made compared with the rest of the Sub-Groups in the Campaign is given by the sub-group rank 530. These statistics are given to motivate Participants to make more Sales. By allowing a Participant to view how many Sales she has made compared to other Participants, the Participant is aware at all times of how close she is to receiving a prize. The prize 535 that the Participant would receive if she maintains her current rank (or if the Sub-Group maintains its current rank) is also provided. This will further motivate the Participant to make even more Sales. An additional feature shown in FIG. 35 is a list of the Supporters 540 who have either purchased products or made a financial contribution to the Campaign and associated their purchase or contribution with the Participant. The Participant may want to send these Supporters an e-mail message or an e-card thanking them for their support, and possibly asking for referrals (additional Potential Supporters).

The Invention as Experienced by the Supporter

FIG. 36 shows how a Supporter would practice the present invention. The Supporter's involvement comprises the following steps:

1. Receiving a Solicitation Message;

2. Visiting the Home Page;

3. Making a purchase or a direct contribution; and

4. Receiving a product or a receipt.

Receiving the Solicitation Message

FIG. 37 shows a sample Solicitation Message that is sent from a Participant (or a Campaign Manager acting on behalf of the Participant) to a Potential Supporter. Uncle Sam is the Potential Supporter in FIG. 37. The text 545 created by the Participant appears, along with the signature message 550 created by the Participant. It is preferable to include a link 555 to the Fundraising Organization's Home Page in the Participant's signature message. A link 560 to the Administrator Home Page may also be included.

Visit the Home Page

FIG. 38 shows a sample Home Page. In some embodiments of the invention the Solicitation Message may be personalized with a personal hyperlink, wherein the personal hyperlink includes the information necessary to identify the Potential Supporter to the system. In this manner, a Potential Supporter following their personal hyperlink would arrive at a Home Page personalized for them. One application of this is to greet the Potential Supporter or display their name at the top of the Home Page. In the example shown in FIG. 38, a Supporter “Uncle Sam” might see his name 565 appear at the top of the Home Page. The text 570, the image 575, the start date 580, and the objectives (i.e., how much money needs to be raised) 585 were selected by the Campaign Manager, as described above in relation to FIG. 4. The Potential Supporter is given two options: to buy a product in support of the Fundraising Organization, or to make a direct financial contribution in support of the Fundraising Organization. To choose the former option, the Potential Supporter selects button 590. To choose the latter option, the Potential Supporter selects button 595.

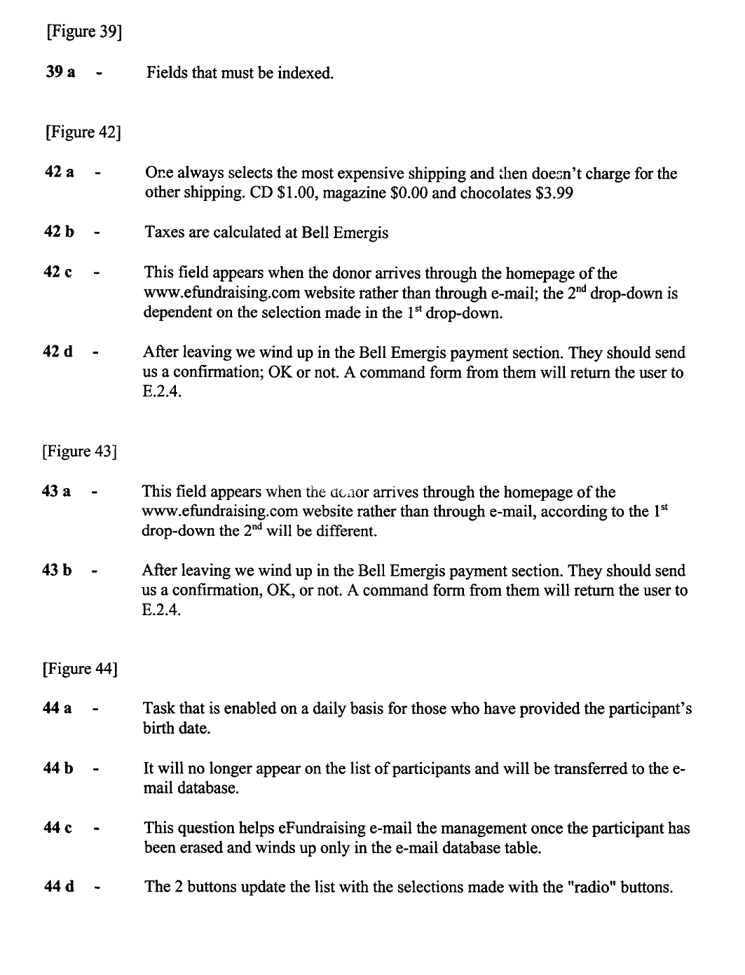

Sometimes Potential Supporters will not receive a Solicitation Message. In addition, it might be that Potential Supporters will not follow the links contained in the Solicitation Message, and will choose instead to visit the Administrator Home Page. One feature of an embodiment of the present invention is the ability to provide a Potential Supporter who visits the Administrator Home Page the ability to search for a Fundraising Organization she would like to support. The screen shown in FIG. 39 provides several searchable categories (although more or fewer may be provided in accordance with the present invention): the name of the Fundraising Organization (box 600), the name of a Participant (boxes 605 and 610), and the state in which the Fundraising Organization exists (pull-down menu 615). The Potential Supporter may enter as much or as little information as she wishes in these categories, and then click on button 620 to begin the Search. Links to all the Home Pages that meet the criteria specified in categories 600 through 615 are displayed on another Web page.

FIG. 40 shows the Home Page as seen by a Potential Supporter who does not follow a link contained in a Solicitation Message. This Home Page is the same as the Home Page displayed in FIG. 38, except that it is not personalized, and hence Uncle Sam's name does not appear.

Make a Purchase or a Contribution

Upon viewing the Home Page, the Potential Supporter may decide to see what products she can purchase to support the Campaign. By clicking on button 590 in FIG. 38, the Potential Supporter is taken to a Web page displaying products, as shown in FIG. 41. Products are arranged according to type. Within each type, there can be several sub-categories. For example, music, candy, and flowers are different types of products. Pop, country, and rap are different sub-categories of music. Potential supporters can view different types of products by selecting pull-down menu 625. Within each type of product, potential supporters can select from different sub-categories of products by selecting pull-down menu 630. A picture and brief description of each product are preferably included on this page. A variety of information may be included with the brief description, including the price and how much of the total purchase price will be received by the Fundraising Organization. To purchase a product, the Potential Supporter specifies the quantity of each product she would like to purchase by filling in box 635 and clicking on button 640. To view a list of all the products that the Potential Supporter has already selected, the Potential Supporter clicks on button 645. To reset all products on a particular page as being unselected, the Potential Supporter clicks on button 650. If the Potential Supporter followed the link from the Solicitation Message she received from a Participant in a particular Campaign, the Potential Supporter's name 646 appears on the screen.

If the Supporter clicks on button 645 in FIG. 41, the shopping basket pictured in FIG. 42 appears. A picture and brief description of the products selected in FIG. 41 appear, along with the price of the product and the amount that will be received by the Fundraising Organization. The quantity box 655 allows the Potential Supporter to change the quantity of a particular product that she is ordering. If the Potential Supporter did not follow a link in the Solicitation Message to the Home Page, then pull-down menu 660 appears. To finalize the purchase of the items listed, the Potential Supporter can select button 665. If the Potential Supporter would like to make additional purchases, she selects button 670.

As stated above, one aspect of the present invention involves associating a purchase or contribution made by a Supporter with a Participant. The shopping basket pictured in FIG. 42 is one way that this feature of the present invention may be implemented. As shown in FIG. 42, pull-down menu 660 allows a Supporter to associate a purchase with a Campaign. This pull-down menu 660 may also be used to allow the Supporter to associate a purchase with a particular Participant. If the Potential Supporter followed a link in a Solicitation Message to the Home Page, then the Participant who found the Potential Supporter (for example, gave the Potential Supporter's e-mail address to the Campaign Manager) would automatically appear in pull-down menu 660. Otherwise, the Supporter could select the Participant's name from a list of all Participants involved in the Campaign.

Potential Supporters who have selected the option of making a direct financial contribution (as opposed to purchasing products) are taken to the page shown in FIG. 43. Potential Supporters can enter the amount of money they would like to contribute in pull-down menu 675. A Potential Supporter may be allowed to choose the amount she would like to contribute from predetermined increments. Alternatively, a Potential Supporter may be allowed to type in the amount she would like to contribute. As with purchases, Supporters may be given the opportunity to associate direct financial contributions with a Participant. If the Fundraising Organization is a charitable organization with a tax registration number, this number may also appear on the screen, so that the Potential Supporter will know that her contribution is tax deductible.

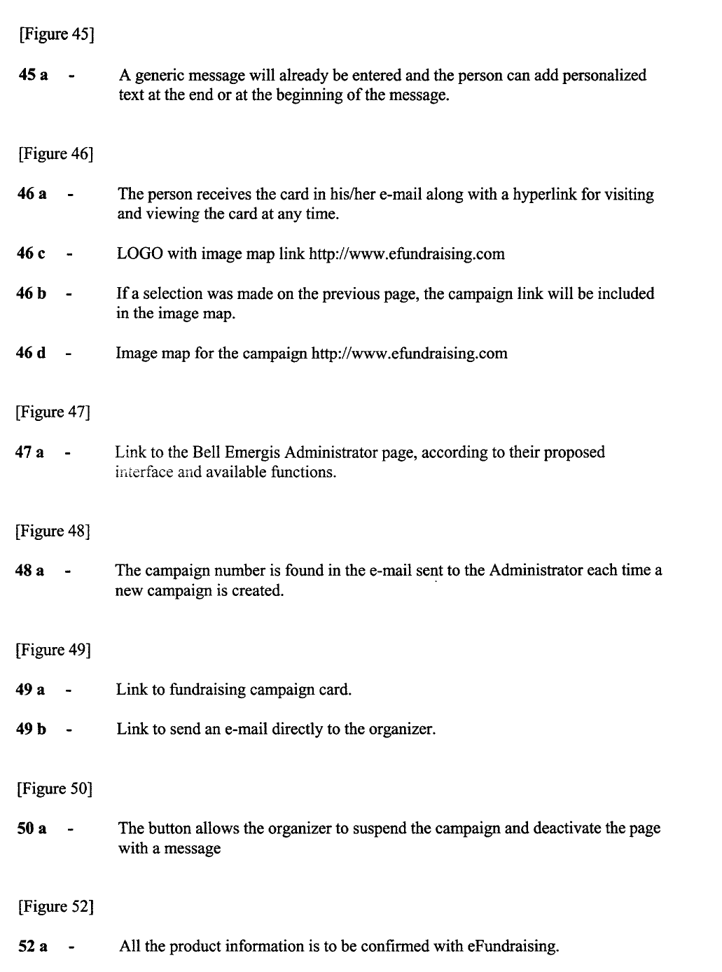

It is a good idea to acknowledge or thank Supporters for their purchases/contributions. This can be accomplished by displaying to Supporters a page similar to that shown in FIG. 44. The Supporter may also be asked several questions, such as whether she wants to be notified of the next Campaign, or whether the Supporter wants to receive information about online fundraising in general. The Supporter may also be given the opportunity to tell a friend about the Participant's Campaign. Supporters often know about additional Potential Supporters that the Participants are unaware of. Therefore, Supporters should be given the opportunity to inform other Potential Supporters about the Campaign. This can be accomplished by displaying to Supporters a page similar to that shown in FIG. 45, which is similar to the page described in FIG. 31. The Supporter enters the friend's name and e-mail address in boxes 680 and 685, respectively. The Supporter's name and e-mail address is provided in boxes 690 and 695, respectively. A generic message 700 may be provided by the Campaign Manager. The Supporter could then add a personalized message, if desired. The Supporter may also select one of several images 705 to send with the message. Alternatively, the Supporter may be given the option of uploading an image to be sent along with the message. The Supporter can enter the name of the Campaign in pull-down menu 710. The Supporter may also include a link to the Fundraising Organization's Home Page. If the Potential Supporter followed the link from the Solicitation Message she received from a Participant in a particular Campaign, the name of that Campaign appears automatically in pull-down menu 710.

The Supporter may be allowed to preview the tell-a-friend message before sending it. FIG. 46 shows a preview of the Supporter's tell-a-friend message. The selected image, the link to one or more Home Pages, and the text written by the Participant all appear just as the person who receives the message would see them.

Receiving the Products or a Receipt

If the Supporter purchases a product, that product is shipped directly to the Supporter. As was discussed above, the Administrator may contract with an outside vendor to supply products for the Campaign. In such case, the outside vendor will ship the product directly to the Supporter. If the Supporter makes a direct financial contribution, the Supporter receives a receipt for tax purposes, if the Fundraising Organization has a tax registration number.

The Invention as Experienced by the Administrator

The Administrator is the organization that manages the fundraising Web site. The Administrator is responsible for:

(i) Managing the Campaigns,

(ii) Managing the products sold during the Campaigns; and

(iii) Collecting money from Supporters.

FIG. 47 shows a screen that may appear to the Administrator after she logs in. This screen provides links to areas of the Administrator Web site where the Administrator can fulfill her responsibilities. Clicking on button 715 allows the Administrator to search for a particular Campaign Manager. Clicking on button 720 allows the Administrator to modify the products that are sold during a particular Campaign. Clicking on button 725 allows the Administrator to send e-mail messages to Campaign Managers and Participants. Clicking on button 730 allows the Administrator to link to the Web site of the organization that collects money from Supporters.

Managing the Campaigns

An Administrator may find it necessary to contact a Campaign Manager. One aspect of the present invention is the ability for an Administrator to search the Database for the e-mail account belonging to a particular Campaign Manager. FIG. 48 shows the screen that appears when the Administrator clicks on button 715 in FIG. 47. The Administrator can fill in as much or as little information as she knows about the Campaign Manager. The Administrator could enter information such as the name of the Fundraising Organization (box 735), the Campaign Manager's name (boxes 740 and 745), the state in which the Campaign Manager's Fundraising Organization exists (pull-down menu 750), and an identification number associated with the Campaign or the Campaign Manager (box 755). The identification number may be assigned by the Administrator, or provided by the Campaign Manager, during the registration step. The Administrator may also search the Database for the e-mail account belonging to a particular Participant.

FIG. 49 shows an example of a screen that displays the results of the Administrator's search. The Campaign Manager's name and e-mail address are listed, along with the name of the Fundraising Organization, the identifier associated with the Campaign, number of Participants, and the total money raised. If a Fundraising Organization has more than one active Campaign, each Campaign would be listed separately.

One aspect of the present invention is that the Administrator has the ability to deactivate a Campaign at any time. This may be useful if the Campaign Manager is, for example, running a Campaign to raise money for an illegal purpose. By selecting link 760 in FIG. 49, the Administrator is taken to the Campaign registration form. This screen is similar to the screen in FIG. 4. However, the screen in FIG. 50 also provides the Administrator with the option to suspend the Campaign by selecting box 765. The Administrator may also use the screen shown in FIG. 50 to modify any of the Campaign information. This may be useful if, for example, the Campaign Manager has included inappropriate material on the Home Page.

Managing the Products Sold

In accordance with the present invention, the Campaign Manager can select which products are to be displayed to Potential Supporters during each Campaign.

Depending on the characteristics (age, gender, etc.) of the Potential Supporters found by Participants, a Campaign Manager may wish to alter the selection of products to be displayed along with the Campaign. For example, if the Potential Supporters for one Campaign are principally retired individuals, the Campaign Manager may wish to choose to display travel magazines or classical music CDs. However, a different Campaign from the same Fundraising Organization may target working parents, in which case news or business magazines and popular or rock music CDs may be more appealing products. In addition, the Campaign Manager can change the price of a product.

The screen in FIG. 51 allows an Administrator to change the products that are displayed along with a particular Campaign. The screen in FIG. 51 is similar to the screen in FIG. 41. Products are arranged according to type. Within each type, there can be several sub-categories. A picture and a brief description of each product are included on this page. Unlike FIG. 41, the screen shown in FIG. 51 allows the Administrator to modify what products are displayed. To delete a particular product, the Administrator selects button 770. To change the price of a product, the Administrator selects button 775.

The Administrator will likely want to add new products from time to time. To add a new product, the Administrator may use the screen shown in FIG. 52. If the Administrator receives products from outside vendors, the Administrator can obtain the information pictured in FIG. 52 from the vendor.

Collecting Money from Supporters

The Administrator is responsible for collecting money from Supporters. There are many ways that the money can be collected. For example, a Supporter may use a credit card to make a purchase (or contribution). The Administrator can accept the Supporter's credit card number online, over the telephone, or even via regular mail. Alternatively, the Supporter could send the Administrator a check through regular mail. Once collected, the money is preferably stored in a trust account in a bank, until the vendor (who supplied the products) and the Fundraising Organization both receive the percentages owed to them.

A Networked Computer System to Operate the Invention

FIG. 53 provides a schematic representation of a possible method for interconnecting components of a networked computer system 780 that can be configured to operate in accordance with the invention. Computer system 780 may include a CPU 790 or other data processing means (e.g., plural processors), and a system memory 800 for storing immediately-executable instructions and immediately-accessible data for the CPU 790 or other processors. System memory 800 typically takes the form of DRAM (dynamic random access memory) and cache SRAM (static random access memory). Other forms of such high-speed memory may also be used. A system bus 810 operatively interconnects the CPU 790 and system memory 800. Computer system 780 may further include non-volatile mass storage means 820 such as a magnetic hard disk drive, a floppy drive, a CD-ROM drive, a re-writeable optical drive, or the like that is operatively coupled to the system bus 810 for transferring instructions and/or data over bus 810. Instructions for execution by the CPU 790 can be introduced into computer system 780 by way of computer-readable media 805 such as a floppy diskette, a CD-ROM optical platter, or other like instructing devices adapted for operatively coupling to, and providing instructions and data for the CPU 790 (or an equivalent instructable machine). The computer-readable media 805 may define a device for coupling to, and causing computer system 780 to perform operations in accordance with the present invention as further described herein.

Computer system 780 may further include I/O (input/output) means 795 for providing interfacing between system bus 810 and peripheral devices such as display 815, keyboard 825 and mouse 830. The I/O means 795 may further provide interfacing to a communications network 835 such as an Ethernet network, a SCSI network, a telephone network, a cable system, the Internet, or the like. Instructions for execution by the CPU 790 can be introduced into computer system 780 by way of data signals transferred over communications network 835. Communications network 835 may therefore define a means for coupling to, and causing computer system 780 to perform operations in accordance with the present invention. The instructing signals that can be transferred through the communications network 835 for causing computer system 780 to perform said operations may also be manufactured in accordance with the present invention.

System memory 800 holds executing portions 840 of the operating system and of any then-executing parts of application programs 850. The application programs 850 generally communicate with the operating system by way of an API (application programming interface) 845. One of the operations that is routinely carried out, is the passing of object-oriented messages from one window object (not shown in FIG. 53) to another such object within system memory 800. Often the operating system 840 will act as an intermediate carrier of such messages. System memory 800 may include memory means for causing computer system 780 to perform various operations in accordance with the present invention as further described herein.

Additional networked computer systems 855 can also be configured to perform various operations in accordance with the present invention. Operations can be distributed among networked computer systems 855 and computer system 780. Additional computer systems 855 and computer system 780 can communicate by way of network 835 to share information, synchronize operations, and perform other tasks and operations in accordance with the present invention as further described herein.

FIG. 54 (and 54a through 54h) illustrate one embodiment of how the individual components of an online system may inter-relate to one another.

The foregoing detailed description of the invention has been presented for purposes of illustration and description. Other features, aspects and objects of the invention can be obtained from a review of the figures and the claims. It is to be understood that other embodiments of the invention can be developed and fall within the spirit and scope of the invention and claims.

What is claimed is:

1. A method of creating a computer network-based fundraising campaign for a fundraising organization, the method comprising:
collecting at least one background fact about the fundraising organization and the fundraising campaign;
providing a home page on a computer network for the fundraising organization;
obtaining a list of at least one potential supporter from the fundraising organization;
sending at least one solicitation message to the at least one potential supporter;
providing a transactional user interface on the computer network through which the at least one potential supporter can support the fundraising organization.

2. The method of claim 1, wherein the transactional user interface lists at least one product that the at least one potential supporter can purchase, wherein a percentage of a purchase price is provided to the fundraising organization if the at least one product is purchased by the at least one potential supporter.

3. The method of claim 2, wherein a purchase of the at least one product is associated with an individual participant.

4. The method of claim 2, wherein the transactional user interface is personalized for each potential supporter.

5. The method of claim 1, wherein the transactional user interface allows the at least one potential supporter to make a direct financial contribution to the fundraising organization.

6. The method of claim 5, wherein the transactional user interface is personalized for each potential supporter.

7. The method of claim 1, wherein the at least one background fact collected from the fundraising organization includes at least one of:
an amount of money that the fundraising organization wants to raise; and
a plan showing how the amount of money will be spent.

8. The method of claim 1, wherein the at least one background fact appears on the home page.

9. The method of claim 1, wherein the list of the at least one potential supporter is maintained in a database, the database associating each potential supporter with the fundraising organization.

10. The method of claim 1, further comprising the step of providing a computer network-based searchable database, wherein the at least one potential supporter can search the database for the home page associated with a particular fundraising organization.

11. The method of claim 1, further comprising the step of providing an electronic mailbox for each of at least one participant.

12. The method of claim 1, further comprising the step of providing a password-protected user interface that is accessible only to a campaign manager from the fundraising organization.

13. The method of claim 12, wherein the password-protected user interface contains at least one fact about the at least one type of product that has been sold by at least one participant.

14. The method of claim 1, further comprising the step of providing at least one reward incentive for at least one participant.

15. The method of claim 1, further comprising the step of encouraging the at least one potential supporter to send at least one solicitation message to at least one other potential supporter.

16. A method of creating a computer network-based fundraising campaign for a fundraising organization, the method comprising:
creating a home page on a computer network for the fundraising organization based on a previous home page from a previous fundraising campaign;
retrieving a list of at least one potential supporter from a database, wherein the at least one potential supporter is associated with the fundraising organization;
sending at least one solicitation message to the at least one potential supporter;
providing a transactional user interface through which the at least one potential supporter can support the fundraising organization.

17. An apparatus for creating a computer network-based fundraising campaign for a fundraising organization, comprising:
a memory, the memory adapted to store a program code; and
a processor in communication with the memory, the program code capable of programming the processor to perform a method for creating a computer network-based fundraising campaign for a fundraising organization, the method comprising the steps of:
collecting at least one background fact about the fundraising organization and the fundraising campaign;
providing a home page on a computer network for the fundraising organization;
obtaining a list of at least one potential supporter from the fundraising organization;
sending at least one solicitation message to the at least one potential supporter;
providing a transactional user interface on the computer network through which the at least one potential supporter can support the fundraising organization.

18. The apparatus of claim 17, wherein the transactional user interface lists at least one product that the at least one potential supporter can purchase, wherein a percentage of a purchase price is provided to the fundraising organization if the at least one product is purchased by the at least one potential supporter.

19. The apparatus of claim 18, wherein a purchase of the at least one product is associated with an individual participant.

20. The apparatus of claim 18, wherein the transactional user interface is personalized for each potential supporter.

21. The apparatus of claim 17, wherein the transactional user interface allows the at least one potential supporter to make a direct financial contribution to the fundraising organization.

22. The apparatus of claim 20, wherein the transactional user interface is personalized for each potential supporter.

23. The apparatus of claim 17, wherein the at least one background fact collected from the fundraising organization includes at least one of:
an amount of money that the fundraising organization wants to raise; and
a plan showing how the amount of money will be spent.

24. The apparatus of claim 17, wherein the at least one background fact appears on the home page.

25. The apparatus of claim 17, wherein the list of the at least one potential supporter is maintained in a database, the database associating each potential supporter with the fundraising organization.

26. The apparatus of claim 17, further comprising the step of providing a computer network-based searchable database, wherein the at least one potential supporter can search the database for the home page associated with a particular fundraising organization.

27. The apparatus of claim 17, further comprising the step of providing an electronic mailbox for each of at least one participant.

28. The apparatus of claim 17, further comprising the step of providing a password-protected user interface that is accessible only to a campaign manager from the fundraising organization.

29. The apparatus of claim 28, wherein the password-protected user interface contains at least one fact about the at least one type of product that has been sold by at least one participant.

30. The apparatus of claim 17, further comprising the step of providing at least one reward incentive for at least one participant.

31. The apparatus of claim 17, further comprising the step of encouraging the at least one potential supporter to send at least one solicitation message to at least one other potential supporter.

32. An apparatus for creating a computer network-based fundraising campaign for a fundraising organization, comprising:
a memory, the memory adapted to store a program code; and
a processor in communication with the memory, the program code capable of programming the processor to perform a method for creating a computer network-based fundraising campaign for a fundraising organization, the method comprising the steps of:
creating a home page on a computer network for the fundraising organization based on a previous home page from a previous fundraising campaign;
retrieving a list of at least one potential supporter from a database, wherein the at least one potential supporter is associated with the fundraising organization;
sending at least one solicitation message to the at least one potential supporter;
providing a transactional user interface through which the at least one potential supporter can support the fundraising organization.
